(19) United States
(12) Patent Application Publication
(10) Pub. No.: US 2024/0391803 A1
(43) Pub. Date: Nov. 28, 2024

(54) IMPROVED LIQUID TREATMENT

(71) Applicant: Arvia Water Technologies Limited, Runcorn (GB)

(72) Inventor: Nigel Brown, Daresbury (GB)

(21) Appl. No.: 18/696,157

(22) PCT Filed: Sep. 27, 2022
(86) PCT No.: PCT/GB2022/052440

§ 371 Date: Mar. 27, 2024

(30) Foreign Application Priority Data
Sep. 27, 2021 (GB) 2113793.0

(51) Int. Cl. C02F 1/467; C02F 1/66; C02F 101/10; C02F 101/36

(52) U.S. Cl. CPC C02F 1/4674; C02F 1/66; C02F 2101/105; C02F 2101/36; C02F 2201/46115; C02F 2209/06; C02F 2301/046

(57) ABSTRACT

The present invention relates to a method for treating a water stream comprising contaminants, the method comprising the steps of: mixing the water stream and a recycle stream in a first ratio to form a combined stream; electrochemically treating the combined stream in a first treatment zone of an electrochemical treatment unit having a first polarity to form a treated combined stream; dividing the treated combined stream into the recycle stream and a finishing stream in a second ratio; and passing the finishing stream to a second treatment zone having the opposite polarity to the first treatment zone to form an output stream. An apparatus for treating a water stream and the use of the method or apparatus for treating a water stream are also described. Various other apparatuses and methods are also provided.

### TECHNICAL FIELD

The present invention relates to methods and apparatuses for the treatment of water streams comprising contaminants, particularly but not exclusively organic contaminants.

The present invention also relates to a current feeder, apparatus comprising a current feeder, as well as methods of operating an apparatus comprising a current feeder. The invention has particular, but not exclusive, application in the treatment of liquids to remove organic pollutants. Although the invention has particular use in the anodic oxidation of organic compounds, it can also be used for cathodic reduction.

The present invention relates to methods and apparatus for the treatment of contaminated liquids by contact with an adsorbent material. The invention has particular, but not exclusive application in the treatments of liquids to remove organic pollutants. Although the invention has particular use in the anodic oxidation of organic compounds, it can also be used for cathodic reduction.

The present invention also relates to apparatuses and methods which combine the methods and apparatuses according to the present invention with other treatment methods and apparatuses to provide more effective treatments.

### BACKGROUND

The electrochemical treatment of water streams comprising organic contaminants is well-known. In such treatments, the water stream is fed into an electrochemical cell and a current passed through it. The anodic current induces oxidation of the organic contaminants, producing gaseous products, resulting in a treated water stream in which the concentration of organic contaminants is reduced.

In some approaches, porous conductive materials are included in the cell onto which the organic contaminants may be adsorbed, thereby concentrating them. This improves the efficiency of the oxidation process when the anodic current is passed through the porous material when it contacts the anode. The destruction of the adsorbed organic contaminants by the oxidation process also regenerates the porous material, enabling it to adsorb further contaminants.

The efficiency of the oxidation reactions at the anodic reactions varies depending on the pH of the water stream, with an acidic pH being generally preferred. Many approaches therefore add significant quantities of acid to the water stream before treatment to ensure the treatment occurs within the more efficient range. This necessitates the addition of significant quantities of base to the treated stream to neutralise the introduced acid.

Adsorbent materials are commonly used in liquid treatment apparatus. Carbon-based adsorbent materials are particularly useful, and are capable of regeneration by the passage of an electric current. The use of carbon-based adsorbents in the treatment of contaminated water is described in the following papers published by the University of Manchester Institute of Science and Technology (now the University of Manchester) in 2004, which are incorporated herein by reference:
Electrochemical regeneration of a carbon-based adsorbent loaded with crystal violet dye by N W Brown, E P L Roberts, A A Garforth and R A W Dryfe Electrachemica Acta 49(2004) 3269-3281
Atrazine removal using adsorption and electrochemical regeneration by N W Brown, E P L Roberts, A Chasiotis, T Cherdon and N Sanghrajka Water Research 39 (2004) 3067-3074

The present invention is directed at apparatus for exploiting the ability of the use of an adsorbent material capable of regeneration in the treatment of contaminated liquids, such as water.

Many methods have been developed to treat aqueous organic wastes. Prior art methods typically exploit the treatment of aqueous organic wastes through the contacting of the waste with a porous material. Porous materials contain internal pores, into which organic components are either adsorbed or absorbed, depending upon the nature of dissolution of the organic component in the water. Irrespective of the take-up mechanism, the presence of internal pores has negative implications for the regeneration of porous materials. Prior research into this area seeks to increase the absorptive capacity of absorbent materials at the expense of complex and difficult regeneration.

Regeneration refers to the removal of contaminants from a material for subsequent re-use. Regeneration can be achieved in a number of ways, including electrochemically, thermally, biologically, and chemically. Electrochemical regeneration may refer to the passage of an electrical current through the material to effect destruction of the adsorbed contaminants via oxidative electrochemical processes. However, as established in “Electrochemical regeneration of granular activated carbon”; R M Narbaitz, J Cen; Wat. Res. 28 (1994) 1771-1778, it can be advantageous to cathodically desorb pollutants and then oxidise the desorbed pollutants at the anode. As such, the treatment involves desorption followed by oxidation. Organic components adsorbed or absorbed into the internal pores of the material are not oxidised when exposed to an electric current. Instead, regeneration of the porous materials is usually achieved using high temperature, high energy, thermal processes with the attendant high financial cost and environmental impact. Alternatively instead of regenerating for reuse, the loaded porous material may be disposed of, e.g. to landfill with the pollutants concentrated in the adsorbent or via incineration with the ash to landfill.

The system and method described in UK patent no. GB2470042B obviates or mitigates many of the problems previously associated with the removal of organic components from aqueous waste. The invention described in this patent relates to the treatment of aqueous organic wastes by the adsorption of the organic components followed by subsequent oxidation of the organic components and simultaneous regeneration of the adsorbent, within a single unit, using relatively low power and circumventing the need to dispose of, or thermally regenerate, the material used during treatment.

The system and method described in UK patent no. GB2504097 covers the use of an apparatus comprising alternating beds of adsorbent material, which alternately act as the anode and the cathode. A flow of contaminated water passes continuously through both the anodic and cathodic beds. In the cathodic beds, the organic contaminants are adsorbed and not oxidised, but in the anodic bed, the organic contaminants are adsorbed and are additionally oxidised. When the current reverses, the anodic bed becomes the cathodic bed, and the cathodic bed becomes the anodic bed. Therefore, organic contaminants which were in the previously cathodic bed are now under oxidising conditions and are oxidised. The adsorbent surface of the previously anodic bed has been electrochemically regenerated and is therefore able to adsorb further organic contaminants from the liquid to be treated. The apparatus of the prior art is used to treat contaminated water in a batchwise manner.

The system and method described in GB2504097 allows the use of a greater mass of adsorbent as the adsorbent in both the anodic and cathodic compartments of the apparatus. In addition, the particulate adsorbent material has a greater surface area than a planar electrode so the current density may be lower, giving a reduced cell voltage. However, this system and method can lead to rapid organic breakthrough in the cathode compartment if the liquid is fed continuously though the system rather than in batches, but the adsorbent material in the cathodic compartment is not being electrochemically regenerated. Organic breakthrough is where the organic contaminants in the liquid to be treated are not adsorbed by the adsorbent material as they pass through the bed and the liquid exiting the apparatus retains high levels of organic contaminants. This usually occurs when the surface of the adsorbent materials is saturated and is consequently unable to adsorb further contaminants. Therefore, whilst there would be an initial reduction in the amount of organic contaminants in the liquid exiting the cathodic bed when the liquid to be treated is passed through a bed of adsorbent material which is not saturated, the adsorbent would quickly become saturated and therefore no further contaminants would be removed from the liquid and the level of contaminants exiting the bed would be the same as the level of contaminants in the liquid before it is passed through the bed. In addition, as the bed is charged, a capacitance is built up in the bed. The capacitance is proportional to the surface area of the adsorbent. The high surface area of the adsorbent particles results in the system having a high capacitance, which may lead to a loss of performance when the current is reversed. In addition, repeated reversal of the direction of current flow can degrade the electrodes.

During the further development of the systems described in UK patent no. GB2470042B and International patent application WO2010/149982 it became apparent that their performance in certain circumstances may be enhanced by the use of an external chemical dosing tank to maintain a low pH within the treatment zone for optimal performance. While performance advantages can be obtained by using an external means to maintain a low pH it would be desirable to obviate the need to provide the dosing tank since this adds to the cost and complexity of the overall decontamination process.

In prior art systems, such as those described in UK patent no. GB2470042B and International patent application WO2010/149982, the cathode is typically provided in an isolated cathode compartment fed with an electrolyte to ensure a high conductivity and therefore a low voltage between the electric current feeders. The electrode assembly consists of a micro-porous membrane, a cathode and chemical dosing system built into one inseparable, sealed “unit” to prevent catholyte leakage or the migration of adsorbent material from the anode compartment through to the cathode compartment. By way of example, one electrode assembly of size 500 mm×500 mm may weigh approximately six kilograms and there can be a number of electrode assemblies in any one unit. If there is a fault with an individual part of the assembly, the entire assembly must be removed from the treatment tank and replaced. To maintain high conductivity in the cathode compartment, a membrane defining micro-pores maintains a high concentration of ionic components in the cathode compartment. The small diameter of the micro-pores prevents the rapid diffusion of ionic components from the solution in the cathode compartment into the solution in the anode compartment. However, suitable micro-porous materials can be unstable in alkaline conditions, which can add additional complexity to the overall treatment process. Furthermore the micro-porous material typically cannot prevent the osmosis of water from the anode compartment into the cathode compartment, which dilutes the electrolyte solution in the cathode compartment and necessitates the addition of further electrolyte throughout operation of the system. There is also the possibility of hydrogen accumulating in the electrode assembly due to the catholyte compartment being isolated. Conveniently, the chemical dosing system may be used to transport away any hydrogen that is produced, however, as mentioned above it would be desirable to obviate the need for the dosing system to reduce the cost and complexity of the system.

An object of the present invention is to obviate or mitigate one or more of the problems currently associated with existing apparatus and methods for treating contaminated liquids, in particular contaminated water.

It is the objective of the present invention to address at least one of the above problems.

### SUMMARY OF THE INVENTION

A first aspect of the present invention relates to a method for treating a water stream comprising contaminants, the method comprising the steps of: a) mixing the water stream and a recycle stream in a first ratio to form a combined stream; b) electrochemically treating the combined stream in a first treatment zone of an electrochemical treatment unit having a first polarity to form a treated combined stream; c) dividing the treated combined stream into the recycle stream and a finishing stream in a second ratio; and d) passing the finishing stream to a second treatment zone having the opposite polarity to the first treatment zone to form an output stream.

The contaminants are preferably organic, but the present invention may be applied to non-organic contaminants.

The first treatment zone may be anodic or cathodic. Preferably, the first treatment zone is anodic.

Electrochemically treating the combined stream may include oxidising at least a portion of the contaminants. This produces protons. The presence of protons alters the pH of the stream.

The water stream has a first pH, which may be substantially neutral, but can also be acidic or alkaline depending on the nature of the water stream being treated. The recycle stream has a second pH, preferably lower than that of the water stream. The pH of the water stream and the pH of the second stream are preferably different.

The water stream and the recycle stream are mixed in a first ratio to produce a combined stream with an intermediate third pH. The first ratio is selected such that the pH of the combined stream is the optimum pH for the electrochemical treatment of the contaminants. The optimum pH will depend on the contaminants being treated and the skilled person would be able to routinely determine the optimal pH.

The electrochemical treatment of the combined stream by electrical current in the anodic treatment zone oxidises at least a portion of the organic contaminants and generates protons which decrease the pH, thereby forming an acidified stream.

The acidified stream is then divided to form the recycle stream, which is mixed with the water stream as described above, and the finishing stream. The finishing stream is provided to the cathodic treatment zone. Due to the presence of hydroxide ions generated in the cathodic zone, the pH of the finishing stream (which has previously been decreased in the anodic zone) is increased, thereby the treated stream. It will be appreciated that the water stream being treated may initially be provided to a cathodic treatment zone to increase its pH and then subsequently to the anodic treatment zone to decrease its pH.

The pH of the water stream and the treated stream may be a first pH. The first pH may be substantially neutral. The pH of the acidified stream, recycle stream and finishing stream may be a second pH. The second pH may be in the range of 1 to 5. The combined stream may be a third pH. The third pH may be an optimal pH for the electrochemical treatment effected by the anodic current. The third pH may be in the range of 1.5 to 4.

It can be appreciated that, in the overall treatment process, the acidification produced by the anodic current and the basification by the cathodic current may be balanced, meaning that pH adjustment is required only to ensure an optimal pH for the electrochemical treatment of the organic contaminants. The inventors have discovered that the necessary pH adjustment can be effected by recycling a portion of the acidified stream that is formed after electrochemical treatment by the anodic current, meaning that the optimal process pH can be maintained with only minimal or even without additions of acid and base throughout the process. As approximately equal amounts of protons and hydroxide ions are produced in an electrochemical cell and are separated by a semi-permeable membrane or an ion-exchange membrane which prevents transfer of the ions therethrough, overall, the pH of the contaminated water entering the system and the pH of the treated water leaving the system is substantially the same. Any known semi-permeable or ion-exchange membrane may be used and the invention is not particularly limited by the exact membrane used. The membrane merely needs to be suitable for minimising the transfer of ions between the different portions of the electrochemical cell. Of course, if the contaminants are themselves acidic, as they are destroyed, the pH of the water will increase accordingly. For example, if the contaminated stream contains an acidic contaminant such as phenol, the initial pH of the contaminated stream may be slightly acidic and the pH of the treated stream may be neutral due to the destruction of the acidic phenol. Even so, the present invention is particularly suitable for relatively low concentrations of contaminants, such as less than around 3000 ppm, so the difference in pH due to destruction of contaminants may be small.

It has been surprisingly found that the separation of acidic protons and alkaline hydroxide ions across a membrane of an electrochemical cell can be used to adjust the pH of a contaminated water stream such that its pH is optimal for destruction of contaminants and then the pH can be adjusted back to its original value (taking account of the destruction of any acidic or alkaline contaminants).

Electrochemically treating the combined stream with an anodic current may oxidise at least a portion of the organic contaminants and produce protons. The organic contaminants are oxidised, ultimately producing carbon dioxide which separates from the acidified stream as a gas. The protons reduce the pH of the water as it is converted from the combined stream to the acidified stream. The portion of the organic contaminants that is oxidised may be greater than about 10%, greater than about 20%, greater than about 30%, greater than about 40%, greater than about 50%, greater than about 60%, greater than about 70%, greater than about 80%, greater than about 90%, or about 100%.

Electrochemically treating the finishing stream with a cathodic current may produce hydroxide ions. The hydroxide ions are formed by the electrochemical reduction of water to form hydroxide ions and hydrogen gas. The hydrogen gas may be collected by any suitable means. The hydroxide ions react with the protons present in the finishing stream, thereby raising the pH of the finishing stream as it is converted to the treated stream and making the pH of the treated stream more similar to the pH of the water stream.

Electrochemical treatment with the anodic or cathodic current may further comprise the step of adsorbing the organic contaminants onto a conductive adsorbent material, such as graphitic particles or NYEX® provided by Arvia Technology Limited, United Kingdom. Conductive adsorbent materials provide surfaces onto which organic contaminants may be adsorbed, effectively increasing their concentration. If the material is conductive, and in contact with the anode, it can directly transmit the anodic current to the high concentration of adsorbed organic contaminants on its surface, thereby increasing the efficiency of the water treatment process. In effect the conducting adsorbent particles act as the electrode.

The first ratio and the second ratio may be selected such that the pH of the treated stream is the same as the pH of the water stream. This is achieved when the anodic current and cathodic current produce equal numbers of protons and hydroxide ions respectively.

The first ratio and/or the second ratio may be in the range of 100:1 to 1:100, preferably in the range of from 1:9 to 1:1. Of course, it will be appreciated that the ratio may be selected depending on the particular requirements at hand, which includes the initial pH of the water to be treated, the potential buffering effect of the water and the optimum pH of treatment.

The first ratio and the second ratio may be the same. This advantageously maintains the volume of water in the system as the volume introduced as the water stream is the same as the volume removed as the finishing (and then treated) stream.

A current may be passed through the combined stream to effect the electrochemical treatment. The current may be in the range of 0.1-1,000 mA/cm², depending on organic concentration, flows and whether a concentrating adsorbent material is present. Preferably the current density will be in the range 0.1-50 mA/cm², but if an adsorbing material is present then the preferred current will be lower in the range 0.1-20 mA/cm² and ideally less than 2.5 mA/cm².

The anodic current and cathodic current may be part of the same electrochemical cell. This ensures that the anodic and cathodic currents are equal, helping to provide protons and hydroxide ions to the process at an equal rate.

The method may further comprise the step of adding acid to the water stream. It may be necessary to add acid to the water stream to ensure that the optimal pH is achieved for the electrochemical oxidation process caused by the anodic current. This may be necessary when the recycle stream is not available, such as when the method is first started (i.e. no recycle stream has yet been produced to mix with the water stream) or when the pH of the water stream or the quantity or identity of the organic contaminants therein changes.

The method may further comprise the step of adding base to the treated stream. The addition of base may be done to ensure that a preferred pH is obtained for the treated stream. For example, in cases where acid has been added to the water stream, base may be added to ensure that the pH of the treated stream is the same as the pH of the initial water stream.

The method may further comprise the step of monitoring the pH of at least one of the water stream, recycle stream, combined stream, acidified stream, finishing stream, and output stream. Monitoring the pH of the various streams permits the efficiency and effectiveness of the process to be monitored. For example, monitoring the pH of the combined stream and the acidified stream allows the strength of the acidifying effect of the anodic current to be determined; monitoring the pH of the finishing stream and treated stream allows the basifying effect of the cathodic current to be determined; and so on. Monitoring the pH of the treated stream also allows for quality control of the overall process. Monitoring the pH of the water stream allows for modification of the method to ensure that the optimum pH is obtained in the combined stream for the electrochemical oxidation process caused by the anodic current.

Further monitoring may also be performed, for example, monitoring of the concentration of organic contaminants at various points in the process to observe efficiency of the method of treatment.

The method may further comprise the step of adjusting the first ratio and/or second ratio to maintain the pH of at least one of the combined stream, acidified stream, recycled stream, finishing stream, and the output stream. Various parameters may be adjusted to maintain desired pH ranges and the overall efficiency of the process. For example, the first ratio may be increased (i.e. the combined stream comprises an increased proportion of the water stream compared to the recycle stream) in response to a decrease in pH of the water stream.

The method may further comprise the step of adjusting the current to maintain the pH of the combined stream, acidified stream, recycled stream, finishing stream, and the output stream. For example, the anodic current may be increased in response to an increase in organic contaminant concentration.

Adjustment of at least one of the first ratio, second ratio, anodic current and cathodic current may be performed by a controller. Control of these parameters may be automated by a controller, reacting in a pre-programmed manner to inputs provided by monitoring apparatus.

The method may include providing sodium chloride to a cathodic one of the treatment zones to produce a sodium hypochlorite solution. It will be appreciated that in an electrochemical treatment unit, there will be a cathodic zone and an anodic zone. Where aqueous sodium hydroxide is provided to a cathodic zone, this generates sodium hypochlorite, which is able to provide additional water treatment. The presence of sodium chloride or another salt will increase the conductivity of the water, thereby reducing the cell voltage resulting in lower operating cost.

The method may include passing at least one of the streams to at least one other water treatment process. The at least one other water treatment process may include electrocoagulation, ion exchange resin, activated carbon, or electrofenton-based treatment.

The at least one other water treatment process may be provided following the step of electrochemically treating the combined stream. In this way, the organic contaminants within the stream have been removed or substantially removed.

It has been surprisingly found that the inclusion of at least one other water treatment process results in treatment which is better than what would be expected by the mere collocation of such water treatment processes. As such, there is an unexpected advantageous synergy between the processes.

Chemical coagulation is a widely used method of treating water and wastewater which includes adding a metal salt that precipitates in the water resulting in the co-precipitation and adsorption of both dissolved and suspended impurities. This results in large quantities of solids that are often toxic as it contains the adsorbed organic contaminants from the water being treated, which is often hazardous. An alternative approach is to use electrocoagulation where the metal salt is generated through the anodic oxidation of steel or aluminium electrodes. Whilst this process produces less of the toxic sludge, it suffers from fouling of the electrode surface. This is because the metal ions dissolve at the anode, but hydroxide ions are produced at the cathode and there is a reaction between the metal and the hydroxide ions, producing the metal hydroxide precipitate.

Since this forms between the electrodes which are closely spaced, fouling of the electrodes occurs. The method of the present invention addresses these shortcomings of the prior art.

In embodiments of the present invention, particularly ones in which the contaminated water includes phosphate, the contaminated water is provided to the anodic portion of the electrochemical treatment unit. Adsorbent material, if present, will adsorb the organics in the water and current passing through the adsorbent material will oxidise the adsorbed contaminants to produce carbon dioxide and hydrogen ions, resulting in a drop in pH. As such, the water leaving the anodic portion of the electrochemical treatment unit will have reduced organic loading and a higher conductivity. The water may then be passed to an electrocoagulation process in which metal ions dissolve in the water from the anode electrode therein and hydroxide ions are produced at the cathode electrode therein. However, due to the presence of the hydrogen ions from the foregoing process, the solution remains acidic meaning that no precipitate is formed. As such, the fouling of the electrodes is reduced or eliminated and one of the major problems of conventional electrocoagulation processes is overcome.

Following treatment, the still-acidic effluent may be mixed with the output from the cathodic portion of the electrochemical treatment unit. Since the output from the cathodic portion of the electrochemical treatment unit contains hydroxide ions, mixing these two streams results in precipitation of the phosphate. Where steel electrodes were used in the electrocoagulation step, the precipitant is iron phosphate. Since this precipitation step is separated from the step in which organics are removed, the resulting sludge contains fewer or substantially no organics and the phosphate can be recovered for reuse rather than being disposed of as a hazardous solid as was previously the case. A further advantage of the present method is that the pH adjustment and mixing can be optimised for the production of the precipitate, such as iron phosphate, rather than it simply being produced as a troublesome precipitate between electrodes that is contaminated with organic contaminants. In addition, the energy required for the electocoagulation process as per the present invention is less than that required for existing systems as the water being treated in the present process has a respectively greater conductivity than would be the case of the same contaminated water being treated in an existing electrocoagulation system, meaning that a lower voltage is required. Alternatively, the same voltage may be used at a higher current such that a smaller plant is required. Furthermore, the separate pH adjustment and mixing means that less iron is required to precipitate the phosphate, reducing the amount that is required to be dissolved from the anode, thereby extending the electrode life. It has also been found that the precipitates produced by the present invention settle faster than in existing electrocoagulation processes.

With regards to the process in which the other treatment method includes ion exchange resin, it has been found that this also results in a surprising synergy that results in treatment which outperforms what would be expected of simply having the two treatment processes combined. Separately, the systems reduces the organic contamination by around 10-15 wt % in each pass. In contrast, the combined system removes from around 80 wt % to around 95 wt % of the dissolved organic carbon in each pass. Without wishing to be bound by scientific theory, it is believed that the hydrophilic components of the natural organic matter are modified in such a way that the ion exchange resin process works more efficiently. A similar effect has been observed if an adsorbent material, for example activated carbon, is used instead of the ion exchange resin.

With regards to the embodiment in which other treatment method is based on electro-Fenton's chemistry, it has been found that the present invention, which allows for the provision of an acidic stream and a basic stream, which can subsequently be recombined to neutralise one another, provides advantages when combined with an electro-Fenton's process.

The Fenton's reaction is used to produce the hydroxyl radical through the mixing of hydrogen peroxide and a soluble ferrous salt. For the reaction to proceed at a reasonable rate, acidic conditions are required. An alternative method of generation hydroxyl radicals based on the Fenton's chemistry is in an electrochemical cell, known as the electro-Fenton process. In this process, air is introduced to the cathode to provide oxygen which can be reduced to produce hydrogen peroxide. Ferric ions are produced through the dissolution of a steel anode and these are then reduced at the cathode to produce ferrous ions that catalyse the reaction. The pH is maintained as acidic, usually at a pH of around 3, which typically requires the addition of a mineral acid to drop the pH followed by the addition of a base to neutralise the solution. The embodiments of the present invention which include a process which relies on electro-Fenton chemistry provides an alternative treatment process where the organics absorb onto an electrically conductive material where they are electrochemically oxidised. Not all of the organics are adsorbed and the addition of the electro-Fenton process step provides a different approach to destroy organics which are not adsorbed. As mentioned, the electrochemical oxidation step generates hydrogen ions and the acidic feed is particularly suitable for the electro-Fenton's process, which relies upon acidic conditions. Again, after passing through the electro-Fenton's process can be mixed with the stream from the cathode to neutralise the hydrogen ions.

A second aspect of the present invention relates to an apparatus for treating a water stream comprising organic contaminants, the apparatus comprising: a mixing means for mixing the water stream and a recycle stream; an electrochemical treatment unit comprising first and second treatment zones, said first treatment zone being in fluid communication with the mixing means, flow dividing means in fluid communication with the first electrochemical treatment zone for dividing a water stream leaving the first electrochemical treatment zone into the recycle stream and a finishing stream, said second electrochemical treatment zone being configured to receive the finishing stream.

The apparatus may be arranged to form a process loop comprising the mixing means, the first electrochemical treatment zone and the flow dividing means; and a finishing spur comprising the flow dividing means and the second electrochemical treatment zone.

The mixing means may be a mixing vessel. The mixing may be effected by moving elements or may be effected by turbulence caused by the mixing of two or more liquid streams.

The first and second electrochemical treatment zones may comprise one or more current feeders operable to operate at a selected current.

The mixing means may operable to mix the water stream and the recycle stream in a first ratio. The mixing means may also be provided with valves, or other means known to the skilled person, to control the quantities the water stream and recycle stream which are mixed. This ultimately permits control of the pH of the combined stream. The mixing means may comprise inline mixers, static mixers, vortices, stirrers, shakers or other mixing devices known to the skilled person as required to induce effective mixing of the water stream and the recycle stream.

The flow dividing means may be operable to divide a stream received from the anode compartment in a second ratio.

The first and second electrochemical treatment zones may be in the form of an electrochemical cell. This ensures that the anodic and cathodic currents are equal, helping to provide equal quantities of protons and hydroxide ions to the process.

The electrochemical cell may comprise a semi-permeable or ion-exchange membrane separating the anode compartment and the cathode compartment. The semi-permeable or ion-exchange membrane allows sufficient ion transport for the operation of the electrochemical cell, while preventing significant reaction between the combined stream and the finishing stream, which would result in an undesirable rise in pH of the former and lowering of pH in the latter.

One of the first and second electrochemical treatment zones may be anodic and the other may be cathodic. The anode compartment and/or the cathode zones may comprise a conductive particulate material. The conductive particulate material allows the organic contaminants to be adsorbed, thereby concentrating them and increasing the efficiency of the electrochemical treatment effected by the anodic current.

The conductive particulate material may comprise graphite particles or NYEX. The skilled person will be aware that any suitable conductive particulate material may be used.

The apparatus may further comprise one or more pH monitors to monitor the pH of the fluid at least one of the inlet, the mixing vessel, the anode compartment, the flow dividing means, the cathode compartment, and the outlet. Any suitable pH monitor apparatus known to the skilled person may be used, such as a pH meter comprising a pH electrode.

The apparatus may further comprise a controller operable to adjust at least one of the current of the anode, the current of the cathode, the first ratio, and the second ratio.

According to a third aspect of the present invention, there is provided the use of the apparatus according to the second aspect of the present invention to treat contaminated water.

According to a fourth aspect of the present invention, there is provided a current feeder comprising a conductor and an envelope comprising a porous separator material. The current feeder according to the fourth aspect of the present invention is able to be used in electrochemical cells and simplifies the construction of such cells. In known electrochemical cells which include a conductive adsorbent material, such as NYEX™ supplied by Arvia Technology Limited, or where the liquid being treated is electrically conductive, in order to avoid short circuiting of the system, it is necessary to include at least one porous separator between the anode and the cathode. The porous separator forces the current out of the conductive adsorbent material and into the liquid before it passes through the porous separator and then back into the conductive adsorbent material. It is the current passing out of the conductive adsorbent material and into the liquid, and then passing back into the adsorbent material after passing through the porous separator which results in anodic oxidation of any contaminants adsorbed onto the conductive adsorbent material.

In known electrochemical treatment cells, where a larger volume of liquid is needed to be treated, additional intermediate current feeders can be provided between the anode and the cathode. Each of the intermediate current feeders will have a porous separator associated on one side in order to avoid short circuiting of the system and to force the current out of and then back into the conductive adsorbent material. As such, it is necessary to divide the bed of conductive adsorbent material into separate sections using the porous separators. This can be difficult to achieve as it is necessary to ensure a good seal around the edge of the porous separator material and this may increase the time and cost of manufacture. In addition, it is not possible to alter the distance between the intermediate current feeders to take account of different operating requirements as the porous separators are fixed in location. In contrast, as it is an independent unit, the current feeder of the first aspect of the present invention is able to be inserted into a water treatment apparatus comprising a bed of conductive adsorbent material without having to seal one portion of the bed from another portion since the electrode is entirely surrounded by the envelope of porous separator material. This has the additional benefit of making replacing the bed of adsorbent more straightforward since there is only a single bed to be replaced.

In addition, by enveloping the conductor with a porous separator material, the conductor can be of any shape and size. As such, different sizes and/or shapes of current feeders may be used in the same apparatus. Furthermore, current feeders can be added and/or removed from the system depending on the treatment requirements. For example, where only low levels of contaminants are present, it is possible to insert a smaller number of current feeders, and where a greater level of contaminants need to be treated, additional current feeders can be added in a straightforward manner.

In addition, in prior art systems, if the porous separator material is somehow damaged and needs replacement, it is necessary to stop the treatment process, drain the system, and remove at least a portion of the bed of conductive adsorbent material in order to access and replace the separator material. This requires the shutdown of the apparatus and leads to delays. It may also require there to be holding tanks for the untreated water to ensure that untreated water is not disposed of. Alternatively, the process which generates the contaminated water may need to be stopped such that the flow of untreated water is halted. Both of these may result in additional costs and/or delays for the operator of the system.

In contrast, the invention according to the fourth aspect of the present application allows for the easy maintenance and repair of any damage to the porous separator material by simply removing the current feeder from the apparatus and either replacing or repairing the porous separator material. This may be done without shutting the apparatus down, thereby reducing the cost impact of needing to provide contaminated liquid storage capacity in the event of a shutdown and/or stopping the process which generates the contaminated water altogether.

Another advantage of the current feeder according to the fourth aspect of the present invention is that it allows the porous separator material to be changed easily. Different porous separator materials have different resistances and are able to operate under different conditions. For example, in some circumstances, a porous separator material which has a low voltage drop across it may be desired whilst in other a porous separator material which is particularly stable at low pH is required. With a current feeder according to the fourth aspect of the present invention, the current feeder may be readily removed from an electrochemical treatment system, as described above, and the envelope may be replaced with an envelope comprising a different material before the current feeder is returned to the system. In this way, the apparatus according to the fourth aspect of the present invention provides a high degree of flexibility and the current feeders may be altered to accommodate different operating conditions, including, for example, different contaminants, different concentrations of contaminant, or different pH values of the liquid being treated. In the apparatus of the prior art, as described above, it is very difficult and time consuming to change the porous separator material and it is therefore not practical to change the porous separator material to take account of changes in operating conditions. It may therefore be necessary to have different sets of apparatus, each adapted to treat a particular waste stream, which will increase the costs for the operator of the system and take up a larger amount of space. Thus, the apparatus according to the fourth aspect of the present invention increases the flexibility of a single set of apparatus and allows it to be used under different conditions.

Yet another advantage of the apparatus according to the fourth aspect of the present invention is that is it possible to collect hydrogen which is generated within the envelope during operation of the current feeder. During operation of the current feeder as a cathode, hydrogen gas is generated. In prior art systems, none of which have electrodes contained within envelopes of porous separator material, the hydrogen gas simply escapes towards the tops of the system and mixes with the gaseous products generated by the oxidation of the contaminants in the apparatus. Where the hydrogen gas is simply allowed to pass into the atmosphere, the concentration of hydrogen gas can build up if there is not suitable ventilation and may present a fire or explosion hazard. By having an envelope, the hydrogen gas is able to be captured and kept separate from the (generally carbonaceous) gaseous products generated from the breakdown of the contaminants. The hydrogen gas can then either be vented to the atmosphere or collected for further use, for example in a hydrogen fuel cell in order to generate electricity that can be passed back into the apparatus. In this way, the apparatus according to the fourth aspect of the present invention may be safer and more efficient than known apparatus.

A yet further advantage of the apparatus according to the fourth aspect of the present invention is that it may be used with existing electrochemical treatment apparatus, including any of the apparatuses described herein, all of which are explicitly considered and disclosed. In particular, the current feeders of the present invention may be readily added to existing treatment systems in order to supplement the existing current feeders. For example, a current feeder according to the present invention may be provided in between two existing current feeders in an existing electrochemical treatment apparatus. Due to the construction of the current feeder of the present invention, it is not necessary to remove the bed of adsorbent material in order to fit a porous separator to divide the bed of adsorbent material, as would be required with other systems.

The conductor is preferably substantially contained within the envelope. It is possible for the electrode to extend out of the envelope, but the envelope preferably extends above an upper portion of the conductive adsorbent material so that the adsorbent material does not come into direct contact with the conductor causing a short circuit when inserted into a bed of conductive adsorbent material. Put another way, the envelope encloses the conductor to an amount greater than the depth into which the current feeder is inserted into the bed of adsorbent material. The depth to which the current feeder according to the present invention may be inserted into the bed of conductive adsorbent material may be varied depending on the particular requirements of the system.

The conductor may be of any size and shape. The conductor may be, for example, circular, rectangular, triangular, or it may be spherical, curved, corrugated, and so on. The conductor is preferably substantially planar to provide it with a large surface area and for the sake of manufacturing convenience. The conductor may be tubular so that it may be fitted into a pipe. The conductor may be in the form of a plate. The envelope is preferably approximately the same shape as the conductor, but not necessarily so. For example, where the conductor is rectangular, the envelope is also preferably rectangular, but a rectangular envelope may be used to enclose, for example, a circular conductor.

The envelope may substantially surround the conductor. In this way, the current feeder may be fully submerged into a bed of conductive adsorbent material without the risk of the current passing directly from the bed of adsorbent material into the conductor. This also ensures that any hydrogen generated within the envelope is contained so that it may be taken off and either vented or put to use.

The envelope may comprise at least one opening. As mentioned above, hydrogen is generated within the envelope and the envelope preferably comprises an opening through which hydrogen gas can be removed. In addition, the conductor is required to be connected to an electrical circuit, so suitable electrical connection means is required to connect the conductor to the circuit. As such, where the envelope is sealed around its entire periphery, the electrical connection must pass through the seal portion or through the at least one opening. The current feeder may comprise a vent. The vent may be a hydrogen vent and may be in the form of a pipe. The pipe may have a coupling portion which is able to be coupled to a hydrogen collection rail. In this way, multiple current feeders, each generating hydrogen gas, can be connected to a common rail to provide a flow of hydrogen gas.

Preferably, the envelope is sealed around its periphery. The envelope is preferably sealed at least in the portion which is located within a bed of conductive adsorbent material in order to prevent the adsorbent material coming into direct contact with the conductor. Where the conductor and envelope are generally rectangular in shape, the envelope may be sealed around substantially three edges, with the upper edge open to allow hydrogen to escape. Of course the envelope may be sealed substantially along each edge to form a sealed unit, with an optional port or vent for hydrogen to escape. By sealed, it is understood that the sealing is suitable for stopping particles of conductive adsorbent material into which the current feeders are inserted in use from entering the envelope. As such, it is conceived that there may be small openings in the seal which may allow for the passage of, for example, water into and out of the envelope.

The conductor may be any suitable material. In order to be suitable, the conductor must be electrically conductive and must also be able to withstand an aqueous environment as well as reducing conditions. Suitable materials include, for example, stainless steel and graphite. The conductor may be in the form of solid metal, expanded metal, perforated metal, and/or mesh metal. Preferably, the conductor is in the form of a perforated metal plate to provide a large surface area and also to provide nucleation points on which hydrogen bubbles may form.

Preferably, the separator is non-conductive. The separator is preferably non-conductive as otherwise there would be a risk of a short circuit between the anode and the cathode. When a current is applied, electrons pass through the pores in the porous separator and enter the conductive adsorbent material within the treatment apparatus. The majority of the electrochemical destruction of adsorbed contaminants takes place in the anodic region near to the separator. If the separator were conductive, the electric current could pass directly through the separator without entering the aqueous liquid and this would result in no or very little electrochemical oxidation of adsorbed contaminants.

By having a separator which is porous, ions are able to pass from one side of the separator to the other. Preferably, the separator allows the passage of water and ions through the pores in the separator. The porous separator may be semi- or selectively permeable or may comprise an ion-exchange membrane. In embodiments in which the porous separator is semi/selectively-permeable or an ion-exchange membrane, this may allow certain ions to pass through the separator, but inhibit or restrict the passage of hydroxide ions through the separator. An accumulation of hydroxide ions in the cathodic zone within the envelope increases the conductivity of the liquid in the cathodic zone and thereby reduces the power requirements of the system. Hydroxide ions may accumulate in the envelope. Due to the application of an electric field and a difference in ion concentrations, water is able to pass into the envelope by electro-osmosis.

Preferably, the porous separator is made of a material which retains its integrity in aqueous environments. Such materials include ceramics, plastics, glasses, polymeric materials and the like. As such, sintered ceramic or glass may be used as the porous separator. Polymeric materials may be in the form of meshes, cloths or membranes and can be made from a range of polymers (PP, PVDC, Polyethylene, Daramic, Nylon, etc). The preferred porous separator material is Nylon or Daramic.

The porous separator material may be a single layer thick. In another embodiment, the porous separator material may comprise multiple layers. Having multiple layers will increase the resistance of the separator and cause a greater drop in the voltage across the separator. This may be advantageous where the contaminant which is to be removed by the apparatus has a high oxidation potential.

According to a fifth aspect of the present invention, there is provided an apparatus for treating a contaminated aqueous liquid by contact with an adsorbent material to provide a treated liquid containing less contamination, the apparatus comprising:
a treatment reservoir having an inlet for contaminated aqueous liquid and an outlet for treated liquid,
a bed of adsorbent material,
a first and a second current feeder for coupling to a source of electrical power,
the first current feeder coupled with the bed of adsorbent material, and
wherein the second current feeder comprises a conductor and an envelope comprising a porous separator material.

The second current feeder according to the fifth aspect of the present invention may comprise any aspect of the current feeder according to the fourth or any other aspect of the present invention.

The apparatus may comprise more than one current feeder according to the fourth aspect of the present invention. One of the advantages of the apparatus according to the present invention is that it allows the number of current feeders to be varied very easily and without a great deal of, if any, downtime of the apparatus. As such, the apparatus can comprise any suitable number of second current feeders.

The porous separator material comprising the envelope may be the same or different for each of the current feeders. As such, the porous separator material comprising the envelope of at least one of the plurality of second current feeders may be different to the porous separator material comprising the envelope of at least one of the other second current feeders.

An advantage of the apparatus of the present invention is that a single anodic current feeder may be provided. By having a single anodic current feeder, the electrical connections are less complex. Of course, it will be appreciated that more than one anodic (first) current feeders may be provided.

Prior art systems have been designed to be symmetric and have equal distances between each current feeder. The intention is to try to maintain equal current density across the apparatus, thereby resulting in equal treatment across the apparatus. However, contrary to conventional practice, with the current feeders according to the fourth aspect of the present invention, it has been found that it is possible to have unequal spaces between current feeders and that the drop in current density across the bed of adsorbent material is acceptable. As such, the apparatus can be made with less stringent tolerances than existing apparatus, which reduces the cost and complexity of manufacture. It also provides more freedom regarding the placement of the anodic current feeder since there is less emphasis on the exact location of the anodic current feeder and it may be placed in the most convenient location. The voltage drop across the bed of adsorbent material may be balanced by using a porous separator material which has a lower resistance in the current feeders which are further away from the anode when compared with current feeders closer to the anode.

Where there is a plurality of second current feeders, they are preferably connected in parallel. Connecting the second current feeders in parallel allows a higher current to be provided using the same voltage, or the same current using a lower voltage when compared to prior art systems having the same treatment capacity. This can save power and may also obviate the need for a transformer to provide the high voltages required by prior art systems.

The inlet and the outlet may be any suitable means for introducing liquid to be treated into and out of the apparatus. The inlet and/or outlet may be in the form of pipes. The inlet and/or outlet may have an associated mesh or filter in order to prevent the adsorbent material from leaving the apparatus.

The apparatus according to the fifth aspect of the present invention may comprise an electrical circuit to which the current feeders may be attached. The second current feeders may be attached in parallel or series, although parallel is preferred. When only a single electrochemical cell is being used, the second current feeders are preferably in parallel. Where there are two or more electrochemical cells, the second current feeders in the different cells may be connected in series. An advantage of this is that the cells are not limited in size.

The second current feeders may comprise hydrogen vents. The apparatus may comprise a common hydrogen rail to which the hydrogen vents may be attached in order to collect the hydrogen generated within the second current feeders.

According to a sixth aspect of the present invention, there is provided a method of treating a contaminated aqueous liquid by contact with an adsorbent material to provide a treated liquid containing less contamination, the method comprising delivering the liquid to an apparatus according to any aspect of the present invention and passing an electric current through the bed of adsorbent material to electrochemically regenerate the adsorbent material, and taking off the treated liquid from the outlet.

Electrochemical regeneration is the process by which the surface of an adsorbent material may be regenerated. Organic contaminants, such as microorganism or organic compounds, entrained within the liquid to be treated are adsorbed onto the surface of the adsorbent material when the liquid passes over the bed of adsorbent material. When an electric current is passed through the adsorbent material, this can destroy the adsorbed contaminant in a number of ways. For example, where a microorganism is adsorbed on the surface of the adsorbent, the current may pass directly through the microorganism resulting in direct destruction of the microorganism. In addition, the localised increase in hydrogen ions during the oxidation of adsorbed organic material and water may lower the pH and thereby damage, destroy, or disrupt the adsorbed microorganism. Further, in cases where chloride ions are present, an oxidised chloride species may be generated by the current and this species may directly chlorinate the adsorbed microorganism. Similarly, adsorbed organic molecules may also be broken down by similar processes of direct electron transfer, hydroxyl radical oxidation or mediated/indirect oxidation. The adsorbed contaminant may be oxidised into carbonaceous gases and water. These will desorb from the surface of the adsorbent material and the surface of the adsorbent material will consequently be available once again to adsorb further contaminants. Thus, the passage of current through the adsorbent material allows for a cycle of adsorption, electrochemical destruction and desorption of the oxidised by-products of contaminants, followed by further adsorption.

In some embodiments according to the method according to the sixth aspect of the present invention, the electric current feeders may be operated continuously. In other embodiments, the electric current feeders may be operated intermittently.

The first and second current feeders may be operated to apply any suitable electric current to the adsorbent material to effect the desired level of oxidation of adsorbed organic matter. The current applied to the current feeders may generate a current density at the separator of 0.001 to 30 mAcm⁻², more preferably a current density of around 1 to 10 mAcm⁻², and most preferably a current density of around 1 to 2.5 mAcm⁻².

The first and second current feeders may be operated to apply any suitable electric current to the adsorbent material to effect the desired level of oxidation of adsorbed organic matter. An electric current of 0.01 to 200 amps may be employed, or even higher depending on the size and number of second current feeders employed within the electrochemical cell, in one embodiment an electric current of around 5 amps may be applied by the current feeders to the adsorbent material, for example when using twelve second current feeders with dimensions of 12 cm by 12 cm at 1.5 mA/cm². The skilled person would appreciate that current density is of most importance to the regeneration of the adsorbent material and would be able to adjust the current employed to take account of the size of the system. As such, a system with a very large area of separator may employ a current considerably in excess of 50 amps in order to reach the desired separator current density.

In systems of the prior art, the key feature is that adsorption and electrochemical destruction of adsorbed contaminants takes place simultaneously, which allows for continuous treatment. However, some contaminants require relatively high voltages to achieve oxidation. For example metaldehyde requires a minimum cell potential of 3 volts to ensure that the oxidation potential at the adsorbent surface is high enough to achieve organic oxidation. The higher oxidation potential can be achieved by increasing the current density, but this would result in an increase in power through both increased current and voltage, which results in higher costs.

Where there are only low concentrations of organic contaminants requiring high oxidation potentials in the liquid to be treated, only a small charge, but high voltage, may be required to oxidise the contaminants. If the current is applied continuously, only a small percentage of the charge is used to oxidise the contaminants and the rest is wasted on side reactions. This results in low current efficiencies. In addition, the increased oxidation potential and the large number of excess electrons can result in oxidative damage to the adsorbent material itself.

It has been surprisingly realised that it is possible to operate the process in an alternative manner by making use of the adsorptive capacity of the adsorbent material. The liquid to be treated may be passed through the bed of adsorbent material continuously resulting in the contaminants in the liquid being continuously adsorbed and concentrated on the surface of the adsorbent material. Due to the adsorptive capacity of the adsorbent material, the liquid may be passed through the bed of adsorbent material for some time before organic breakthrough occurs. Before organic breakthrough occurs, the current may be turned on at a current density high enough to produce the voltage required for oxidation of the particular compounds in the liquid to be treated. When the current is being applied, electrochemical destruction and/or oxidation of the contaminants takes place and thereby regenerates the surface of the adsorbent to allow further contaminants to be adsorbed. The period of applying the current may be less than the period required for adsorption. Since the current is only applied intermittently, although the same current density is required, it is required for a shorter period of time. As such, the energy requirements are lower overall and cost savings can be achieved. In addition, potential damage to adsorbent material through side reactions may also be reduced.

Although the intermittent application of current to regenerate the beds of adsorbent material has particular application in respect of the present invention, the skilled person would recognise that methods and apparatus for treating contaminated liquids utilising adsorbent materials may also benefit from intermittent operation of the current feeders.

As such, the current feeders may be operated intermittently. Preferably, the current feeders are operated prior to when organic breakthrough occurs. The intermittent application of current may be utilised where the concentration of contaminants in the liquid to be treated is variable. In addition, due to the ability to readily alter the number and distribution of the second current feeders according to the present invention, it is also possible to change the total surface area of the plurality of second current feeders thereby altering the current density adjacent each of the second current feeders, assuming a constant overall current is maintained.

The current feeders may be operated at a first voltage which is sufficiently high to result in oxidation of a first contaminant and intermittently operated at a second voltage which is higher than the first voltage in order to oxidise the second contaminant. As such, the current can be varied to intermittently oxidise organic contaminants in the liquid to be treated. The current may be completely turned off between periods when the current is increased to a level required to oxidise adsorbed contaminants, or it may be reduced to a lower level in order to maintain a degree of current passing through the adsorbent material.

The variation in current densities applied to the adsorbent materials may be advantageous in cases where there is more than one contaminant in the liquid, the contaminants may require different oxidation potentials to be oxidised. In the prior art, the current density would have been held at a level required to oxidise the contaminant with the highest oxidation potential. As such, the power requirement would be high and energy costs would also be high.

In addition to increasing the current applied to the bed of adsorbent material in order to treat organic contaminants with a high oxidation potential, it has been surprisingly realised that it is possible to boost the oxidation potential in a system by using a chemical additive. In particular, it has been surprisingly realised that the addition of hydrogen peroxide to the methods and apparatus of the present invention can enhance the performance of the system.

When added to the apparatus of the present invention, the hydrogen peroxide is reduced at the cathode to form water and a hydroxyl radical. Although treatment generally occurs in the anodic bed, the addition of hydrogen peroxide results in the production of a strong oxidising agent in the cathodic bed. The hydroxyl radical is able to assist in the breakdown of any remaining contaminants.

The oxidation potential of the hydroxyl radical produced is 2.8 V, which is greater than that of ozone (2.08 V), chlorine (1.36 V) or hydrogen peroxide (1.78 V).

As such, there is provided the use of hydrogen peroxide in the apparatus and methods of any aspect of the present invention.

Adsorbent materials suitable for use in the methods and apparatus of any aspect of the present invention are solid materials capable of convenient separation from the liquid phase and capable of electrochemical regeneration. Preferred adsorbent materials comprise adsorbent materials capable of electrochemical regeneration, such as graphite, unexpanded graphite intercalation compounds (UGICs) and/or activated carbon, preferably in powder, granular, or flake form. Typical individual UGIC particles suitable for use in the present invention have electrical conductivities in excess of 10,000 Ω⁻¹ cm⁻¹. Such materials are sold under the name NYEX® by Arvia Technology Limited, UK. It will be appreciated however that in a bed of particles of the adsorbent material the electrical conductivity of the bed will be significantly lower as there will be resistance at the particle/particle boundary. Hence it is desirable to use as large a particle as possible to keep the resistance as low as possible. In addition the larger particles will settle faster allowing a higher flow rate to be achieved. However, increasing the particle size will result in a reduction in the available surface area, so a balance is required over high settlement rates and low cell voltages against the reduction in adsorptive capacity from a reduction in surface area. It will be appreciated however that a large number of different UGIC materials have been manufactured and that different materials, having different adsorptive properties, can be selected to suit a particular application of the method of the present invention. The adsorbent material may consist only of UGICs, or a mixture of such graphite with one or more other adsorbent materials. Individual particles of the adsorbent material can themselves comprise a mixture or composite of more than one adsorbent material. The adsorbent material may comprise a composite material of two or more carbonaceous materials. The adsorbent beds may comprise a mixture of two or more adsorbent materials. The kinetics of adsorption should be fast because the adsorbent material has no internal surface area and therefore the kinetics are not limited by diffusion of the organic contaminant to the internal surface. The adsorbent material may be NYEX™, which is sold by Arvia Technology Limited, UK.

The capability of materials to undergo electrochemical regeneration will depend upon their electrical conductivity, surface chemistry, electrochemical activity, morphology, electrochemical corrosion characteristics, and the complex interaction of these factors. A degree of electrical conductivity is necessary for electrochemical regeneration and a high electrical conductivity can be advantageous. Additionally, the kinetics of the electrochemical oxidation of the adsorbate must be fast. The kinetics depend upon the electrochemical activity of the adsorbent surface for the oxidation reactions that occur and also on the pH of the liquid phase. Electrochemical regeneration will generate corrosive conditions at the adsorbent surface. The electrochemical corrosion rate of the adsorbent material under regeneration conditions should be low so that the adsorption performance does not deteriorate during repeated cycles of adsorption and regeneration. Moreover, some materials can passivate upon attempted electrochemical regeneration, often due to the formation of a surface layer of non-conducting material. This may occur, for example, as a result of the polymerisation of the contaminant, for example phenol, on the surface of the adsorbent. Additionally, electrochemical destruction of the organic components on the adsorbent material will generate reaction products which must be transported away from the surface of the adsorbent material. The structure of the adsorbent material being regenerated can influence the rate of transport of the products away from the surface of the adsorbent material, and it will be appreciated that it is desirable to use adsorbent materials that facilitate this transport process. This will depend upon both the surface structure and chemistry of the adsorbent material.

It will be appreciated that preferred adsorbent materials for the present invention will desirably have an ability to adsorb organic compounds. The ability of the material to absorb is not essential, and in fact may be detrimental. The process of adsorption works by a molecular interaction between the organic component and the surface of the adsorbent. By contrast, the process of absorption involves the collection and at least temporary retention of an organic component within the pores of a material. By way of example, expanded graphite is known to be a good absorber of a range of contaminants (e.g. up to 86 grams of oil can be ‘taken-up’ per gram of compound). UGICs have effectively no absorption capacity. They can adsorb, but the adsorption capacity is very low as the surface area is low (e.g. up to 7 milligrams of oil can be ‘taken-up’ per gram of compound per adsorption cycle). These figures demonstrate a difference of four orders of magnitude between the take-up capacity of expanded graphite and that of UGICs. The selection of UGICs for use in the present invention arises from carefully balancing its high regeneratability against its relatively low take-up capacity.

Whilst the particle size is not critical, the optimum size will depend on the adsorbent and electrical properties required. The material used and particularly the particle size is a compromise between surface area, electrical conductivity and ease of separation. Preferred materials are graphite intercalation compounds (GICs). A particularly preferred GIC is a bi-sulphate intercalated product. It can be formed by chemically or electrochemically treating graphite flakes in oxidising conditions in the presence of sulphuric acid. However, a large number of different GIC materials have been manufactured and different materials will have different adsorptive properties which will be a factor in selecting a particular material.

The higher the electrical conductivity of the adsorbent material, the lower will be the voltage required across the cell and so the lower the power consumption. It is generally desirable to use as large a particle as possible to keep the resistance as low as possible. Hence a bed of fine wet particles has been shown to have an electrical conductivity of 0.16 Ω⁻¹ cm⁻¹ compared to 0.32 Ω⁻¹ cm⁻¹ for a bed of larger particles. As a comparison, a bed of granular and powdered activated carbon would typically have electrical conductivities of 0.025 and 0.012 Ω⁻¹ cm⁻¹ respectively.

The preferred GIC used in the practice of the present invention is in flake form, and typically has a composition of at least 95% carbon, and a density of around 2.225 g cm⁻³. However, flake carbons can be used as the starting materials for producing GICs with significantly lower carbon contents (80% or less). These compounds can also be used within the cell, but are likely to result in slightly higher voltages across the electrochemical regeneration stage. Other elements will also be present within the GIC, these compounds are dependent on the initial composition of the flake graphite and chemicals used to convert the flakes into intercalated form. Different sources of graphite can produce GICs with different adsorptive properties. The adsorbent material may be NYEX™, which is sold by Arvia Technology Limited, UK.

According to a seventh aspect of the present invention, there is provide the use of the apparatus or method according to any aspect of the present invention in a process for the treatment of a contaminated aqueous liquid.

According to an eighth aspect of the present invention, there is provided apparatus for treating a contaminated aqueous liquid by contact with an adsorbent material to provide a treated liquid containing less contamination, the apparatus comprising:
a tubular treatment reservoir having an inlet for contaminated aqueous liquid and an outlet for treated liquid,
a bed of adsorbent material,
a first and a second current feeder for coupling to a source of electrical power,
a porous separator disposed between the bed of adsorbent material and the first current feeder,
the second current feeder coupled with the bed of adsorbent material,
wherein the treatment reservoir comprises a further portion comprising a non-porous, insulating material, wherein at least a portion of the second current feeder is separated from the first current feeder by the non-porous, insulating material.

In some embodiments, at least a portion of the further portion of the treatment reservoir is provided between the first and second current feeders.

The second current feeder is preferably remote from the porous separator. By having the second current feeder remote from the porous separator and the first current feeder, the potential of the adsorbent bed is more uniform. This provides a situation where the potential difference across the separator (which provides the greatest electrical resistance) is constant resulting in the same current density through all parts of the separator. Consequently, the amount of electrochemical oxidation is also more uniform. This allows a greater proportion of the bed to be involved in the treatment of the contaminated liquid since the current can be adjusted such that the potential in the bed of adsorbent material is sufficient to result in electrochemical oxidation of the organics and the regeneration of the adsorbent material. This also reduces wear on the adsorbent material since there are fewer areas of the bed of adsorbent material which have to handle increased currents compared to the remainder of the bed.

The non-porous, insulating portion of the treatment reservoir effectively separates the second current feeder from the porous separator in order to force the current into the adsorbent material, which is around four orders of magnitude more conductive that the aqueous liquid to be treated. The current is then able to pass through the entirety of the bed rather than through the liquid. In order to pass through the porous separator, the electrons must exit the adsorbent material and enter the liquid. If there is adsorbent material on the other side of the porous separator, the current may enter such adsorbent material. On the other hand, if there is a liquid on the other side, which may or may not be conductive, and no adsorbent material, the current will pass through the liquid to the first current feeder. In the absence of the non-porous, insulating portion of the treatment reservoir, any parts of the cell with lower resistivity will be subject to larger currents as the electricity would take the path of least resistance. Preferably, the second current feeder is substantially within the non-porous, insulating further portion, and/or is located below the further portion away from the first current feeder. The second current feeder is preferably located adjacent the side of the non-porous, insulating portion remote from the first current feeder.

In embodiments, there is provided adsorbent material between the porous separator and the first current feeder. By having adsorbent material between the porous separator and the first current feeder, this provides a current path with greater conductivity and thereby reduces the energy required to pass the current from the porous separator to the first current feeder.

In embodiments, there is no adsorbent material provided between the porous separator and the first current feeder. Instead, a liquid is provided between the porous separator and the first current feeder. The liquid may be the liquid to be treated or any other liquid. The liquid may be conductive. In the space between the first current feeder and the porous separator, hydroxide ions are formed. If the porous separator freely allows passage of ionic species, including hydroxide species, the concentration of hydroxide ions will not significantly increase as they will diffuse away and/or react with hydrogen ions created on the other side of the porous separator. Therefore, there will not be a significant increase in the conductivity of the water. If the porous separator is semi-permeable and restricts the flow of ionic species, the concentration of hydroxide ions will increase and consequently increase the conductivity of the liquid. This will lead to lower power requirements for the apparatus. Hence depending on the application, it may be beneficial to build up the concentration of hydroxide ions to reduce power or it may be beneficial to allow the hydroxide ions to cross through the porous membrane to neutralise the hydrogen ions in the anode compartment to correct the pH. Since the number of hydroxide ions and hydrogen ions produced in the cathodic and anodic compartments respectively are approximately the same, auto pH correction can occur. Alternatively, the excess electrolyte (produced due to electro-osmosis) can be collected and subsequently used to achieve pH correction.

At least a portion of the second current feeder may be planar. Having a planar current feeder allows a more even distribution of current in the bed of adsorbent material to which it is coupled. The planar electrode may be substantially perpendicular to the porous separator.

At least a portion of the second current feeder may be annular. At least a portion of the second current feeder may be tubular/in the form of a tube. It will be appreciated that the cross section of the tube may be of any appropriate shape. It is preferable for the cross section to be substantially circular, but it is also possible for the cross section to be any other shape, such as, for example, square, triangular, or oval. It is less desirable for the cross sectional shape to include corners and/or points as this may result in higher current densities at the corners or edges, but it will be appreciated that in some circumstances, it is still possible to use tubes having cross-sections which include corners and/or points.

Preferably, the porous separator is sealed at the bottom and open at the top. During operation, hydrogen, and potentially other gases, may be produced in the gap between the first current feeder and the porous separator. If the porous separator were sealed at both ends, this would lead to a build-up of gas which may ultimately result in damage to the apparatus. Since the porous separator is not sealed at the top, it is possible for any hydrogen generated to simply pass upwardly through the liquid and be vented or collected. It will be appreciated that if the flow rate of the liquid to be treated is generally downwards and is sufficiently high, as bubbles of hydrogen gas exit the top of the porous separator, they may be entrained in the flow and pass downwardly with the flow of liquid.

The tubular treatment reservoir may comprise any suitable material. The tubular treatment reservoir may be defined by the porous separator. The porous separator may be in the form of a tube and will define the shape of at least a portion of the bed of adsorbent material. The tubular treatment reservoir may be the area enclosed by the porous separator in which treatment of the liquid takes place. The tubular treatment reservoir may be defined by the bed of adsorbent material coupled to the second current feeder. The tubular treatment reservoir may be only partially tubular. A mesh or filter may be provided at the top and/or bottom of the treatment reservoir. The function of the mesh or filter is to stop the adsorbent material in the adsorbent bed from leaving the treatment reservoir, whilst allowing the liquid to be treated and the treated liquid to pass into and/or out of the apparatus.

The tubular treatment reservoir may be substantially surrounded by the first current feeder. The first current feeder may comprise at least a portion of a wall surrounding the treatment reservoir. The material of the first current feeder may be conductive itself, such as a metal. Where the material is a metal, it is preferably stainless steel, although it will be recognised that any other suitable metal may be used. Suitably, a stainless steel pipe could be used as the first current feeder. The first current feeder may comprise an insulating material coated with a conducting material, such as a conducting paint, or may enclose a substantially annular current feeder abutting or in close proximity to the inside of the insulating material.

The first current feeder may be elongate such that it is substantially tubular. The first current feeder may be non-continuous. The first current feeder may extend through an arc of the wall of the treatment reservoir.

By using a metallic pipe to comprise the first current feeder and a wall around the treatment reservoir, it is possible to provide a cheap and robust treatment apparatus. Since the wall around the treatment reservoir can act as the current feeder as well as support the treatment reservoir, fewer components are required when compared to prior art systems. In addition, the first current feeder can be made from standard lengths of pipe and no special fabrication is required. The diameter and/or length of the pipe can be varied depending on the application to allow larger or smaller capacities.

In some embodiments, the wall around the treatment reservoir, which may be the first current feeder, may comprise a flange. There may be a flange at the top and/or bottom of the apparatus. The flange may be used to connect the apparatus of the first aspect of the present invention into a pipe carrying a contaminated aqueous liquid. As such, the apparatus according to the first aspect of the present invention is able to be incorporated into existing pipework to allow the liquid in the pipe to be treated. Apparatus of the prior art is unable to be integrated as easily into existing pipework as the apparatus according to the first aspect of the present invention.

In another embodiment of the eighth aspect of the present invention, the wall of the treatment reservoir, which may be the first current feeder, may comprise one or more holes. The apparatus of the first aspect of the present invention may further comprise a tank. The tank may surround the apparatus. The tank may be filled with a conducting catholyte solution. The one or more holes in the wall of the treatment reservoir function to allow the conducting catholyte solution to fill the gap between the first current feeder and the separator and to allow any gas generated at the cathode to exit. In this embodiment, the top of the porous separator may also be sealed. Therefore, it is necessary to provide one or more holes in the walls of the treatment reservoir in order to allow any gases, such as hydrogen, produced to exit. In this embodiment, the catholyte solution may be any suitable solution, such as a sodium chloride solution or a sodium sulphate solution. It will be appreciated that other catholytes may be used.

When a current is passed between the current feeders in this embodiment, the reduction of water at the cathode will create hydroxide ions. These hydroxide ions will increase the pH of the catholyte solution. The catholyte solution may be flushed through the system over time such that all of the original electrolytes, such as sodium chloride, will be removed from the catholyte solution. However, since significant quantities of hydroxide ions would have been formed due to the passage of current through the system, the liquid will retain its conductivity. Thus, it is possible to run a treatment system which is substantially free of electrolytes and instead relies on the presence of hydroxide ions created at the cathode.

In a further embodiment, the wall of the treatment reservoir may not be present. Preferably, the first current feeder is remote from the porous separator. In this case, the treatment reservoir may be surrounded by a catholyte solution and the first current feeder is coupled to the catholyte solution. In this way, the treatment reservoir does not require a wall and instead is located within a tank. Alternatively or additionally, the treatment reservoir may be substantially surrounded by a bed of adsorbent material coupled to the first current feeder. The first current feeder is preferably remote from the second current feeder. The non-porous, insulating portion of the treatment reservoir separates the first and the second current feeders and separates the second current feeder from the porous separator such that any current passing between the current feeders via the porous separator preferentially passes into the adsorbent material and thereby causes the whole of the bed of adsorbent material to be at a substantially uniform potential. Having a bed of adsorbent material on both sides of the separator acting as the electrodes can lead to a decrease in power requirements due to the increased conductivity of the adsorbent material compared to the liquid and the higher surface area of three dimensional electrodes.

In an embodiment of the eighth aspect of the present invention, there may be provided a plurality of tubular treatment reservoirs. The plurality of treatment reservoirs may be connected in series. When connected in series, the outlet for treated liquid of one reservoir feeds the inlet of the following reservoir.

Preferably, the tubular reservoirs are connected in parallel. When connected in parallel, the reservoirs may share a common connection to the electrical power source. In the apparatus of the prior art, in order to increase the amount of liquid which could be treated, it is necessary to add additional cells to the apparatus. In such cases, in order for the current to remain at the same level through each cell, the voltage needs to be increased, as the amount of oxidation achieved is proportional to the charge passed. In addition, some contaminants require a minimum potential for them to be oxidised. Keeping the current density through the cell constant will maintain the oxidation potential across the cell. When the apparatus of the first aspect of the present invention is connected in parallel, this allows a higher current to be provided using the same voltage.

A plurality of treatment reservoirs may be connected to a common chamber. The common chamber may comprise a bed of adsorbent material. In this way, the adsorbent material forms a continuous bed which is connected to each treatment reservoir. This allows the adsorbent material to be filled and taken out more easily than in prior art systems. Since there is effectively only a single continuous bed, it is possible for the adsorbent material to be flushed out of the reservoirs and the common chamber at once, and it is not necessary to fill or empty each reservoir individually.

The common chamber may be provided with an outlet for treated liquid. The common chamber may have a mesh or filter between the bed of adsorbent material and the outlet in order to retain the adsorbent material within the apparatus. Treated water is able to pass through the mesh or filter. The mesh or filter may be removable in order to allow the adsorbent material to be removed from the apparatus and/or refilled as appropriate.

The plurality of treatment reservoirs may be location in a tank and surrounded by a catholyte solution and/or a bed of adsorbent material. In an embodiment, the treatment reservoirs are at least substantially surrounded by individual walls, which may be in the form of pipes.

Where there is a plurality of reservoirs, they may be connected to a common plate. The plate is preferably conductive and may be a metallic plate comprising a plurality of holes. The first current feeders surrounding the tubular reservoirs may be inserted into the holes and bonded to the plate in a way which allows current to pass between the plate and the current feeders. For example, the current feeders may be bonded to the plate by welding, braising, conductive adhesive, or any other suitable means. By having a common plate to which each of the first current feeders is attached, it is possible to have a single electrical connection rather than individual connections for each reservoir. This reduces the complexity of the apparatus and also reduces the possibility of an individual reservoir losing power thereby causing the treatment of the contaminated liquid to stop in such reservoir.

According to any embodiment of the eighth aspect of the present invention, the liquid to be treated may be delivered to the top of the tubular reservoir(s) and taken off from the bottom of the reservoir(s). In this way, the liquid flows generally downwards and slightly compresses the bed of adsorbent material. This increases the conductivity of the adsorbent bed and means that a reduced power can be used. However, if there are any particulate materials in the water to be treated, these may be caught in the upper portion of the adsorbent bed and could potentially build up leading to a reduction in flow or even a blockage. In order to address this possibility, it is possible to backwash the system by passing liquid upwardly through the bed or beds of adsorbent material.

In the alternative, the liquid to be treated may be delivered to the bottom of the tubular reservoir(s) and taken off from the top of the reservoir(s). In this way, the liquid flows generally upwards through the adsorbent bed and slightly separates the particles of adsorbent material. This lowers the conductivity of the bed, but has the advantage of allowing any particulate materials to pass up through the bed. Further, any gases generated by the treatment process are able to pass out of the apparatus along with the flow of liquid. Since it is necessary for a current to pass through the bed to allow electrochemical regeneration of the adsorbent material, the upward flow must be less than that required to fluidise the bed. It is a matter of routine to determine this rate. The rate of the upwards flow should be less than the settlement rate of the adsorbent material. Furthermore, any gas generated in the apparatus is able to pass out of the system in the same direction as the upwards flow.

According to a ninth aspect of the present invention, there is provided apparatus for treating a contaminated aqueous liquid by contact with an adsorbent material to provide a treated liquid containing less contamination, the apparatus comprising:
a tubular treatment reservoir having an inlet for contaminated aqueous liquid and an outlet for treated liquid,
a bed of adsorbent material,
a first and a second current feeder for coupling to a source of electrical power,
a porous separator disposed between the bed of adsorbent material and the first current feeder,
at least a portion of the wall of the reservoir defining the first current feeder,
at least a portion of the second current feeder being elongate and located in the bed of adsorbent material such that said second current feeder is spaced from said first current feeder.

In one embodiment of the ninth aspect of the present invention, the first current feeder substantially surrounds the tubular treatment reservoir. Preferably, at least a portion of the wall of the reservoir is the first current feeder.

The wall of the tubular treatment reservoir may comprise any suitable material. The material may be conductive itself, such as a metal. Where the material is a metal, it is preferably stainless steel, although it will be recognised that any other suitable metal may be used. Part of this tube may be coated with an insulating paint/material to provide a separate zone for the second current feeder. Alternatively the material comprising the wall of the tubular treatment reservoir may comprise an insulating material coated with a conducting material, such as a conducting paint, or may enclose a substantially annular current feeder abutting or in close proximity to the inside of the insulating material.

The annular current feeder may be elongate such that the current feeder is substantially tubular. The first current feeder may be non-continuous. The first current feeder may extend through an arc of the wall of the treatment reservoir.

A mesh or filter may be provided at the top and/or bottom of the or each treatment reservoir. The function of the mesh or filter is to stop the adsorbent material in the adsorbent bed from leaving the treatment reservoir, whilst allowing the liquid to be treated and the treated liquid to pass into and/or out of the apparatus.

By using a metallic pipe to form the treatment reservoir and the first current feeder, it is possible to provide a cheap and robust treatment apparatus. Since the wall around the treatment reservoir can act as the current feeder as well as support the treatment reservoir, fewer components are required when compared to prior art systems. In addition, the reservoir can be made from standard lengths of pipe and no special fabrication is required. The diameter and/or length of the pipe can be varied depending on the application to allow larger or smaller capacities.

The apparatus may comprise a flange. There may be a flange at the top and/or bottom of the apparatus. The flange may be used to connect the apparatus of the first or second aspects of the present invention into a pipe carrying a contaminated aqueous liquid. As such, the apparatus according to the eighth and ninth aspects of the present invention is able to be incorporated into existing pipework to allow the liquid in the pipe to be treated. Apparatus of the prior art is unable to be integrated as easily into existing pipework as the apparatus according to the eighth aspect of the present invention. Where there is a plurality of reservoirs, they may be connected to a common plate. The plate is preferably conductive and may be a metallic plate comprising a plurality of holes. The first current feeders surrounding the tubular reservoirs may be inserted into the holes and bonded to the plate in a way which allows current to pass between the plate and the current feeders. For example, the current feeders may be bonded to the plate by welding, braising, conductive adhesive, or any other suitable means. By having a common plate to which each of the first current feeders is attached, it is possible to have a single electrical connection rather than individual connections for each reservoir. This reduces the complexity of the apparatus and also reduces the possibility of an individual reservoir losing power thereby causing the treatment of the contaminated liquid to stop in such reservoir.

Preferably, the porous separator is sealed at the bottom and open at the top. During operation, hydrogen, and potentially other gases, may be produced in the gap between the first current feeder and the porous separator. If the porous separator were sealed at both ends, this would lead to a build-up of gas which may ultimately result in damage to the apparatus. Since the porous separator is not sealed at the top, it is possible for any hydrogen generated to simply pass upwardly through the liquid and be vented or collected.

The second current feeder may comprise any suitable material. Preferably, the second current feeder is a carbon rod. Preferably, the second current feeder is positioned substantially equidistant from the walls of the treatment reservoir. In particular, the second current feeder is positioned such that when the reservoir is viewed in horizontal cross section, the second current feeder is located substantially in the centre. The second current feeder may be substantially concentric with the treatment reservoir. Of course, it will be appreciated that the second current feeder does not necessarily have to be located in the centre of the reservoir and, in some circumstances, it may be desirable to position the second current feeder away from the centre.

Preferably, the porous separator is disposed inboard of the wall of the treatment reservoir. In any of the embodiments of any aspect of the present invention, the porous separator may be made of any suitable material. The porous separator is preferably non-conductive. The porous separator may be permeable or semi/selectively permeable.

The porous separator may be of any suitable construction and material. The porous separator stops the conductive adsorbent material from coming into direct contact with the cathode thereby causing a short circuit between the anode and the cathode. The porous separator is configured to prevent carbon-based adsorbent material from passing out of the adsorbent bed, but to permit water and/or ionic species to pass through. The separator may be any material which prevents the short-circuiting of the cell or the carbon-based adsorbent material from passing out of the adsorbent bed. Thus, materials such as paper or cotton wool may be used, although these are generally not preferred since they can degrade rapidly.

Preferably, the separator is non-conductive. The separator is preferably non-conductive as otherwise there would be a risk of a short circuit between the anode and the cathode. When a current is applied, electrons pass through the pores in the porous separator and enter the conductive adsorbent material within the treatment reservoir. The majority of the electrochemical destruction of adsorbed contaminants takes place in the anodic region near to the separator. If the separator were conductive, the electric current could pass directly through the separator without entering the aqueous liquid and this would result in no or very little electrochemical oxidation of adsorbed contaminants.

By having a separator which is porous, this allows ions to pass from one zone to another. Preferably, the separator allows the passage of water and ions through the pores in the separator. The porous separator may be semi- or selectively permeable or may comprise an ion-exchange membrane. In embodiments in which the porous separator is semi/selectively-permeable or an ion-exchange membrane, this may allow certain ions to pass through the separator, but inhibit or restrict the passage of hydroxide ions through the separator. An accumulation of hydroxide ions in the cathodic zone increases the conductivity of the liquid in the cathodic zone and thereby reduces the power requirements of the system. In the apparatus according to the first and second aspects of the present invention, hydroxide ions may accumulate in the gap between the wall of the reservoir and the porous separator. Due to the application of an electric field and a difference in ion concentrations, water is able to pass from into the space between the porous separator and the wall of the tubular reservoir by electro-osmosis.

Preferably, the porous separator is made of a material which retains its integrity in aqueous environments. Such materials include ceramics, plastics, glasses, polymeric materials and the like. As such, sintered ceramic or glass may be used as the porous separator. Polymeric materials may be in the form of meshes, cloths or membranes and can be made from a range of polymers (PP, PVDC, Polyethylene etc).

The apparatus of the eighth or ninth aspect of the present invention may comprise a single unit having a single tubular treatment reservoir. Where a greater amount of liquid is needed to be treated, it is possible to connect a plurality of units together. The tubular reservoirs may be connected in series. When connected in series, the outlet for treated liquid of one reservoir feeds the inlet of the following unit.

Preferably, the tubular reservoirs are connected in parallel. When connected in parallel, the reservoirs may share a common connection to the electrical power source. In the apparatus of the prior art, in order to increase the amount of liquid which could be treated, it is necessary to add additional cells to the apparatus. In such cases, in order for the current to remain at the same level, through each cell, the voltage needs to be increased, as the amount of oxidation achieved is proportional to the charge passed. In addition, some contaminants require a minimum potential for them to be oxidised. Keeping the current density through the cell constant will maintain the oxidation potential across the cell. When the apparatus of the present invention is connected in parallel, this allows a higher current to be provided using the same voltage. The current may be that described in relation to any aspect of the present invention.

According to a tenth aspect of the present invention, there is provided apparatus for treating a contaminated aqueous liquid by contact with an adsorbent material to provide a treated liquid containing less contamination, the apparatus comprising:
a plurality of tubular treatment reservoirs, each having:
an inlet for contaminated aqueous liquid and an outlet for treated liquid,
a bed of adsorbent material,
a first and a second current feeder for coupling to a source of electrical power,
a porous separator disposed between the bed of adsorbent material and the first current feeder,
at least a portion of the walls of the reservoirs defining the first current feeder,
at least a portion of the second electrodes being located in the bed of adsorbent material such that said second current feeders are spaced from said first current feeders.

The apparatus according to the tenth aspect of the present invention is similar to that according to the ninth aspect of the present invention.

In the apparatus according to the tenth aspect of the present invention, the plurality of treatment reservoirs may each be connected to a common chamber. The common chamber may comprise a bed of adsorbent material. In this way, the adsorbent material forms a continuous bed which is in connection with each treatment reservoir. This allows the adsorbent material to be filled and taken out more easily than in prior art systems. Since there is effectively only a single continuous bed, it is possible for the adsorbent material to be flushed out of the reservoirs and the common chamber at once, and it is not necessary to fill or empty each reservoir individually.

The common chamber may be provided with an outlet for treated liquid. The common chamber may have a mesh or filter between the bed of adsorbent material and the outlet in order to retain the adsorbent material within the apparatus. Treated water is able to pass through the mesh or filter, but the adsorbent material is not. The mesh or filter is removable in order to allow the adsorbent material to be removed and/or refilled as appropriate.

The second current feeders may be coupled together such that only a single electrical connection is required. At least a portion of the second current feeders may be elongate.

In an alternative embodiment, the individual second current feeders in the tubular treatment reservoirs are not present and instead, there is provided a current feeder operably connected to the bed of adsorbent material. Preferably, such current feeder is located substantially in the common chamber and is in electrical contact with the bed of adsorbent material. There may be one or a plurality of current feeders located substantially in the common chamber. Preferably, such current feeder or feeders are substantially planar. Preferably such current feeder or feeders are remote from the porous separators and/or the first current feeder(s).

In order to avoid a short circuit between the current feeders, as with the other embodiments of the first and second aspects of the present invention, there is provided an insulating portion between oppositely charged current feeders. Since there is an insulating portion between the current feeders, the current must pass through the porous separator. In this context, ‘between’ does not require an insulating portion located in a direct line between current feeders. The term ‘between’ can include arrangements in which the insulating portion stops a direct path of current flow between the current feeders and/or serves to increase the distance between the second current feeder and the closest part of the porous separator.

In an embodiment, the second current feeder is remote from the porous separators. Current will generally flow through the path of least resistance. By having the second current feeder remote from the porous separator, this makes the potential of the adsorbent bed more uniform. This provides a situation where the potential difference across the separator (which provides the greatest electrical resistance) is constant resulting in the same current density through all parts of the separator. Whilst it will be appreciated that it is not possible to entirely eliminate any differences in potential across the whole bed, separating the second current feeder from the porous separator results in a more even distribution of current through the separator.

As discussed above, the second current feeders in the apparatus according to the tenth aspect of the present invention may be connected in parallel. In the event that the liquid leaving the treatment reservoirs requires further treatment, it may be recycled back into the inlet of the treatment reservoirs. Alternatively, any liquid requiring further treatment may be passed to a second apparatus comprising a plurality of treatment reservoirs. Thus, the two sets of apparatus may be connected in series. As such, whereas in the prior art, the individual units were connected in series in order to increase their capacity and then groups of units would be connected in parallel, in the present invention, individual treatment units are connected in parallel and the groups of units may be connected in series.

According to an eleventh aspect of the present invention, there is provided apparatus for treating a contaminated aqueous liquid by contact with an adsorbent material to provide a treated liquid containing less contamination, the apparatus comprising:
a tank,
a treatment reservoir having an inlet for contaminated aqueous liquid and an outlet for treated liquid,
a bed of adsorbent material,
a first and a second current feeder for coupling to a source of electrical power,
a porous separator disposed between the bed of adsorbent material and the first current feeder,
the second current feeder coupled with the bed of adsorbent material,
wherein the tank contains a catholyte solution coupled to the first current feeder and the porous separator is arranged in at least one column extending into the tank, the adsorbent material being contained within the at least one column.

The apparatus according to the eleventh aspect of the present invention shares a number of similarities with that of the eighth aspect of the present invention. However, the apparatus according to the eleventh aspect of the present invention comprises a tank containing a catholyte solution that surrounds the porous separator and does not have the individual treatment reservoirs defined by separate pipes. Since the catholyte solution is conductive, it is possible to use a single current feeder to charge the whole of the catholyte solution and it is not necessary to have current feeders, such as those in the form of tubes or pipes, surrounding the column or columns of the porous separator material. This further simplifies the apparatus and reduces the requirement to having a single current feeder. Of course, it will be appreciated that multiple current feeders could be operably connected with the catholyte solution. In addition, any gas generated in the catholyte is able to pass up through the catholyte solution for recovery or disposal. It should also be appreciated that the higher conductivity of the catholyte will result in a higher concentration of ions within the separator. Since the separator is likely to have the highest electrical resistance, the higher conductivity of the catholyte will reduce the cell voltage.

According to a twelfth aspect of the present invention, there is provided a method of treating a contaminated aqueous liquid by contact with an adsorbent material to provide a treated liquid containing less contamination, the method comprising delivering the liquid to an apparatus according to the any aspect of the present invention and passing an electric current through the bed of adsorbent material to electrochemically regenerate the adsorbent material, and taking off the treated liquid from the outlet.

Electrochemical regeneration is the process by which the surface of an adsorbent material may be regenerated. Organic contaminants, such as microorganism or organic compounds, entrained within the liquid to be treated are adsorbed onto the surface of the adsorbent material when the liquid passes over the bed of adsorbent material. When an electric current is passed through the adsorbent material, this can destroy the adsorbed contaminant in a number of ways. For example, where a microorganism is adsorbed on the surface of the adsorbent, the current may pass directly through the microorganism resulting in direct destruction of the microorganism. In addition, the localised increase in hydrogen ions during the oxidation of adsorbed organic material and water may lower the pH and thereby damage, destroy, or disrupt the adsorbed microorganism. Further, in cases where chloride ions are present, an oxidised chloride species may be generated by the current and this species may directly chlorinate the adsorbed microorganism. Similarly, adsorbed organic molecules may also be broken down by similar processes of direct electron transfer, hydroxyl radical oxidation or mediated/indirect oxidation. The adsorbed contaminant may be oxidised into carbonaceous gases and water. These will desorb from the surface of the adsorbent material and the surface of the adsorbent material will consequently be available once again to adsorb further contaminants. Thus, the passage of current through the adsorbent material allows for a cycle of adsorption, electrochemical destruction and desorption of the oxidised byproducts of contaminants, followed by further adsorption.

In some embodiments, the electric current feeders may be operated continuously. In other embodiments, the electric current feeders may be operated intermittently.

The first and second current feeders may be operated to apply any suitable electric current to the adsorbent material to effect the desired level of oxidation of adsorbed organic matter. The current applied to the current feeders may generate a current density at the separator of 0.001 to 30 mAcm⁻², more preferably a current density of around 0.5 to 10 mAcm⁻², and most preferably a current density of around 1 to 2.5 mAcm⁻².

The first and second current feeders may be operated to apply any suitable electric current to the adsorbent material to effect the desired level of oxidation of adsorbed organic matter. An electric current of 0.01 to 50 amps may be employed, in one embodiment an electric current of around 5 amps may be applied by the current feeders to the adsorbent material. The skilled person would appreciate that current density is of most importance to the regeneration of the adsorbent material and would be able to adjust the current employed to take account of the size of the system. As such, a system with a very large area of separator may employ a current considerably in excess of 50 amps in order to reach the desired separator current density.

In systems of the prior art, the key feature is that adsorption and electrochemical destruction of adsorbed contaminants takes place simultaneously, which allows for continuous treatment. However, some contaminants require relatively high voltages to achieve oxidation. For example metaldehyde requires a minimum cell potential of 3 volts to ensure that the oxidation potential at the adsorbent surface is high enough to achieve organic oxidation. The higher oxidation potential can be achieved by increasing the current density, but this would result in an increase in power through both increased current and voltage, which results in higher costs.

Where there are only low concentrations of organic contaminants requiring high oxidation potentials in the liquid to be treated, only a small charge, but high voltage, may be required to oxidise the contaminants. If the current is applied continuously, only a small percentage of the charge is used to oxidise the contaminants and the rest is wasted on side reactions. This results in low current efficiencies. In addition, the increased oxidation potential and the large number of excess electrons can result in oxidative damage to the adsorbent material itself.

It has been surprisingly realised that it is possible to operate the process in an alternative manner by making use of the adsorptive capacity of the adsorbent material. The liquid to be treated may be passed through the bed of adsorbent material continuously resulting in the contaminants in the liquid being continuously adsorbed and concentrated on the surface of the adsorbent material. Due to the adsorptive capacity of the adsorbent material, the liquid may be passed through the bed of adsorbent material for some time before organic breakthrough occurs. Before organic breakthrough occurs, the current may be turned on at a current density high enough to produce the voltage required for oxidation of the particular compounds in the liquid to be treated. When the current is being applied, electrochemical destruction and/or oxidation of the contaminants takes place and thereby regenerates the surface of the adsorbent to allow further contaminants to be adsorbed. The period of applying the current may be less than the period required for adsorption. Since the current is only applied intermittently, although the same current density is required, it is required for a shorter period of time. As such, the energy requirements are lower overall and cost savings can be achieved. In addition, the damage to adsorbent material through side reactions may also be reduced.

Although the intermittent application of current to regenerate the beds of adsorbent material has particular application in respect of the present invention, the skilled person would recognise that methods and apparatus for treating contaminated liquids utilising adsorbent materials may also benefit from intermittent operation of the current feeders.

As such, the current feeders may be operated intermittently. Preferably, the current feeders are operated prior to when organic breakthrough occurs. The intermittent application of current may be utilised where the concentration of contaminants in the liquid to be treated is variable.

The current feeders may be operated at a first voltage which is sufficiently high to result in oxidation of a first contaminant and intermittently operated at a second voltage which is higher than the first voltage in order to oxidise the second contaminant. As such, the current can be varied to intermittently oxidise organic contaminants in the liquid to be treated. The current may be completely turned off between periods when the current is increased to a level required to oxidise adsorbed contaminants, or it may be reduced to a lower level in order to maintain a degree of current passing through the adsorbent material.

The variation in current densities applied to the adsorbent materials may be advantageous in cases where there is more than one contaminant in the liquid, the contaminants may require different oxidation potentials to be oxidised. In the prior art, the current density would have been held at a level required to oxidise the contaminant with the highest oxidation potential. As such, the power requirement would be high and energy costs would also be high.

In view of the possibility of intermittently applying a current, it is possible to use a solar powered system to provide the required power. As such, the current feeders may be connected to a photovoltaic cell, commonly referred to as a solar panel. During the day, the solar panel is able to generate direct current which can be passed to the current feeders and used to effect electrochemical oxidation of adsorbed contaminants. The power generated by the solar panel will vary during the day and will peak when the sun is at its strongest. Thus, adsorbed contaminants may be treated during the day. Hence the system can be used to treat liquid overnight using adsorbent and then the adsorbent is regenerated the next day when solar power is available once more. It can be appreciated that as well as using a photo-voltaic panel direct across the cell, it would be possible to use the panel (or other forms of renewable energy) to charge a battery that can then be used to power the electrochemical cell

In addition to increasing the current applied to the bed of adsorbent material in order to treat organic contaminants with a high oxidation potential, it has been surprisingly realised that it is possible to boost the oxidation potential in a system by using a chemical additive. In particular, it has been surprisingly realised that the addition of hydrogen peroxide to the methods and apparatus of the present invention can enhance the performance of the system.

When added to the apparatus of the present invention, the hydrogen peroxide is reduced at the cathode to form water and a hydroxyl radical. Although treatment generally occurs in the anodic bed, the addition of hydrogen peroxide results in the production of a strong oxidising agent in the cathodic bed. As such, oxidation can be achieved in both the anodic and cathodic portions of the apparatus.

The oxidation potential of the hydroxyl radical produced is 2.8 V, which is greater than that of ozone (2.08 V), chlorine (1.36 V) or hydrogen peroxide (1.78 V).

As such, there is provided the use of hydrogen peroxide in the apparatus and methods of any aspect of the present invention.

Adsorbent materials suitable for use in the methods and apparatus of any aspect of the present invention are solid materials capable of convenient separation from the liquid phase and electrochemical regeneration. Preferred adsorbent materials comprise adsorbent materials capable of electrochemical regeneration, such as graphite, unexpanded graphite intercalation compounds (UGICs) and/or activated carbon, preferably in powder, granular, or flake form. Typical individual UGIC particles suitable for use in the present invention have electrical conductivities in excess of 10,000 Ω⁻¹ cm⁻¹. It will be appreciated however that in a bed of particles of the adsorbent material the electrical conductivity of the bed will be significantly lower as there will be resistance at the particle/particle boundary. Hence it is desirable to use as large a particle as possible to keep the resistance as low as possible. In addition the larger particles will settle faster allowing a higher flow rate to be achieved. However, increasing the particle size will result in a reduction in the available surface area, so a balance is required over high settlement rates and low cell voltages against the reduction in adsorptive capacity from a reduction in surface area. It will be appreciated however that a large number of different UGIC materials have been manufactured and that different materials, having different adsorptive properties, can be selected to suit a particular application of the method of the present invention. The adsorbent material may consist only of UGICs, or a mixture of such graphite with one or more other adsorbent materials. Individual particles of the adsorbent material can themselves comprise a mixture or composite of more than one adsorbent material. The adsorbent material may comprise a composite material of two or more carbonaceous materials. The adsorbent beds may comprise a mixture of two or more adsorbent materials. The kinetics of adsorption should be fast because the adsorbent material has no internal surface area and therefore the kinetics are not limited by diffusion of the organic contaminant to the internal surface. The adsorbent material may be NYEX™, which is sold by Arvia Technology Limited, UK.

The capability of materials to undergo electrochemical regeneration will depend upon their electrical conductivity, surface chemistry, electrochemical activity, morphology, electrochemical corrosion characteristics, and the complex interaction of these factors. A degree of electrical conductivity is necessary for electrochemical regeneration and a high electrical conductivity can be advantageous. Additionally, the kinetics of the electrochemical oxidation of the adsorbate must be fast. The kinetics depend upon the electrochemical activity of the adsorbent surface for the oxidation reactions that occur and also on the pH of the liquid phase. Electrochemical regeneration will generate corrosive conditions at the adsorbent surface. The electrochemical corrosion rate of the adsorbent material under regeneration conditions should be low so that the adsorption performance does not deteriorate during repeated cycles of adsorption and regeneration. Moreover, some materials can passivate upon attempted electrochemical regeneration, often due to the formation of a surface layer of non-conducting material. This may occur, for example, as a result of the polymerisation of the contaminant, for example phenol, on the surface of the adsorbent. Additionally, electrochemical destruction of the organic components on the adsorbent material will generate reaction products which must be transported away from the surface of the adsorbent material. The structure of the adsorbent material being regenerated can influence the rate of transport of the products away from the surface of the adsorbent material, and it will be appreciated that it is desirable to use adsorbent materials that facilitate this transport process. This will depend upon both the surface structure and chemistry of the adsorbent material.

It will be appreciated that preferred adsorbent materials for the present invention will desirably have an ability to adsorb organic compounds. The ability of the material to absorb is not essential, and in fact may be detrimental. The process of adsorption works by a molecular interaction between the organic component and the surface of the adsorbent. By contrast, the process of absorption involves the collection and at least temporary retention of an organic component within the pores of a material. By way of example, expanded graphite is known to be a good absorber of a range of contaminants (e.g. up to 86 grams of oil can be ‘taken-up’ per gram of compound). UGICs have effectively no absorption capacity. They can adsorb, but the adsorption capacity is very low as the surface area is low (e.g. up to 7 milligrams of oil can be ‘taken-up’ per gram of compound per adsorption cycle). These figures demonstrate a difference of four orders of magnitude between the take-up capacity of expanded graphite and that of UGICs. The selection of UGICs for use in the present invention arises from carefully balancing its high regeneratability against its relatively low take-up capacity.

Whilst the particle size is not critical, the optimum size will depend on the adsorbent and electrical properties required. The material used and particularly the particle size is a compromise between surface area, electrical conductivity and ease of separation. Preferred materials are graphite intercalation compounds (GICs). A particularly preferred GIC is a bi-sulphate intercalated product. It can be formed by chemically or electrochemically treating graphite flakes in oxidising conditions in the presence of sulphuric acid. However, a large number of different GIC materials have been manufactured and different materials will have different adsorptive properties which will be a factor in selecting a particular material.

The higher the electrical conductivity of the adsorbent material, the lower will be the voltage required across the cell and so the lower the power consumption. It is generally desirable to use as large a particle as possible to keep the resistance as low as possible. Hence a bed of fine wet particles has been shown to have an electrical conductivity of 0.16 Ω⁻¹ cm⁻¹ compared to 0.32 Ω⁻¹ cm⁻¹ for a bed of larger particles. As a comparison, a bed of granular and powdered activated carbon would typically have electrical conductivities of 0.025 and 0.012 Ω⁻¹ cm⁻¹ respectively.

The preferred GIC used in the practice of the present invention is in flake form, and typically has a composition of at least 95% carbon, and a density of around 2.225 g cm⁻³. However, flake carbons can be used as the starting materials for producing GICs with significantly lower carbon contents (80% or less). These compounds can also be used within the cell, but are likely to result in slightly higher voltages across the electrochemical regeneration stage. Other elements will also be present within the GIC, these compounds are dependent on the initial composition of the flake graphite and chemicals used to convert the flakes into intercalated form. Different sources of graphite can produce GICs with different adsorptive properties.

According to a thirteenth aspect of the present invention, there is provided a current feeder substantially surrounded with a porous separator and having an opening at the top of the porous separator. There is also provided an apparatus comprising a tank comprising a bed of adsorbent material in electrical connection with a second current feeder and one or a plurality of current feeders according to any aspect of the present invention connected to a source of electrical power having the opposite charge to the second current feeder.

According to a fourteenth aspect of the present invention, there is provide the use of the apparatus or method according to any aspect of the present invention in a process for the treatment of a contaminated aqueous liquid.

Each of the aspects of the present invention may be combined with any of the other aspects of the present invention except where they are technologically incompatible. For example, any of the methods can be operated using any of the apparatuses described herein. Any of the configurations of electrochemical cell/units, current feeders, separators, or conductive adsorbent materials may be used in any of the apparatuses or methods described herein.

The apparatus may further comprise pumps, valves, resistors, tanks and other ancillary apparatus that is necessary or helpful.

### BRIEF DESCRIPTION OF THE FIGURES

FIG. 1A is a schematic of an apparatus for electrochemical treatment of a water stream using a conventional electrochemical treatment method with a single electrode chamber.

FIG. 1B is a chart showing the relative pH values of various streams in the apparatus of FIG. 1A.

FIG. 2A is a schematic of an apparatus for electrochemical treatment of a water stream using a conventional electrochemical treatment method with separate anode and cathode chambers.

FIG. 2B is a chart showing the relative pH values of various streams in the apparatus of FIG. 2A.

FIG. 3A is a schematic of an apparatus for electrochemical treatment of a water stream using an electrochemical treatment method according to the present invention.

FIG. 3B is a chart showing the relative pH values of various streams in the apparatus of FIG. 3A.

FIG. 4 is a flow diagram of a method/apparatus according to the present invention.

FIGS. 5A and 5B are photographs of the electrodes of an electrocoagulation treatment unit in which the feed stream has not been acidified and the electrodes of an electrocoagulation treatment unit in which the feed stream has been acidified in accordance with the present invention.

FIG. 6 is a graph showing a comparison of the effectiveness at phosphate removal of an electrocoagulation treatment unit in which the feed stream has not been acidified and one in which the feed stream has been acidified in accordance with the present invention.

FIGS. 7A and 7B are bar charts comparing the effectiveness of removal of dissolved organic carbon (DOC) from water.

FIGS. 8A and 8B are schematic depictions of a current feeder in accordance with the present invention.

FIG. 9 is a schematic depiction of an electrochemical cell which does not utilise the current feeders according to the present invention.

FIG. 10 is a schematic representation of an electrochemical treatment system according to the present invention.

FIG. 11 is a schematic representation of a tubular electrochemical treatment system according to the present invention.

FIG. 12 is a vertical cross section through an embodiment of the apparatus according to the thirteenth aspect of the present invention

FIG. 13 is a vertical cross section through a second exemplary embodiment of the apparatus according to the thirteenth aspect of the present invention;

FIG. 14 is a vertical cross section through a third exemplary embodiment of the apparatus according to the thirteenth aspect of the present invention;

FIG. 15 is a vertical cross section through a fourth embodiment of the apparatus according to the thirteenth aspect of the present invention;

FIG. 16 is a vertical cross section through a fifth embodiment of the apparatus according to the thirteenth aspect of the present invention having multiple treatment reservoirs as well as an embodiment the present invention;

FIG. 17 is a vertical cross section through a sixth embodiment of the apparatus according to the thirteenth aspect of the present invention having multiple treatment reservoirs as well as an embodiment of the present invention;

FIG. 18 is a vertical cross section through a seventh embodiment of the apparatus according to the thirteenth aspect of the present invention;

FIG. 19 is a vertical cross section through an embodiment of the apparatus according to the fourteenth aspect of the present invention;

FIG. 20 is a vertical cross section through a second embodiment of the apparatus according to the fourteenth aspect of the present invention having multiple treatment reservoirs;

FIG. 21 is a schematic representation of an electrode in accordance with an embodiment of the present invention; and

FIG. 22 is a schematic representation of a plurality of electrodes according to an embodiment of the present invention used in an exemplary treatment apparatus.

### DETAILED DESCRIPTION

The following description is in relation to particular embodiments of the present invention and is not intended to be limiting. The skilled person will understand that there are many permutations and variations which differ from the following description which do not depart from the scope of the present invention, with the scope of the invention being defined by the appended claims.

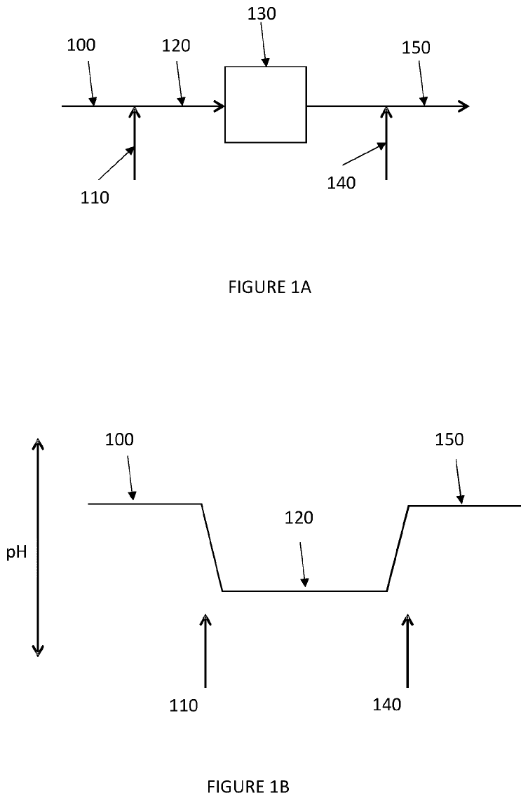

FIG. 1A depicts a schematic drawing of an existing apparatus for the treatment of a water stream comprising organic contaminants. In the related method of treating the water stream 100, the water stream 100 is mixed with an acid 110 to form a combined stream 120. The combined stream 120 is then fed to electrochemical cell 130 comprising an anode and a cathode (not shown). Current is passed through the electrochemical cell 130 to allow the anodic current to oxidise at least a portion of the organic contaminants. The combined stream 120 then leaves the electrochemical cell 130, whereupon it is mixed with base 140, which neutralises the acid added initially. As a result, the treated stream 150 possesses a pH equal to that of the initial water stream 100.

The variation in pH throughout this process is depicted FIG. 1B, which shows the pH of the water stream 100 being reduced by the addition of the acid to give a lower pH combined stream 120. The pH of the combined stream 120 is then raised back to the initial pH of the water stream 100 to form the treated stream 150.

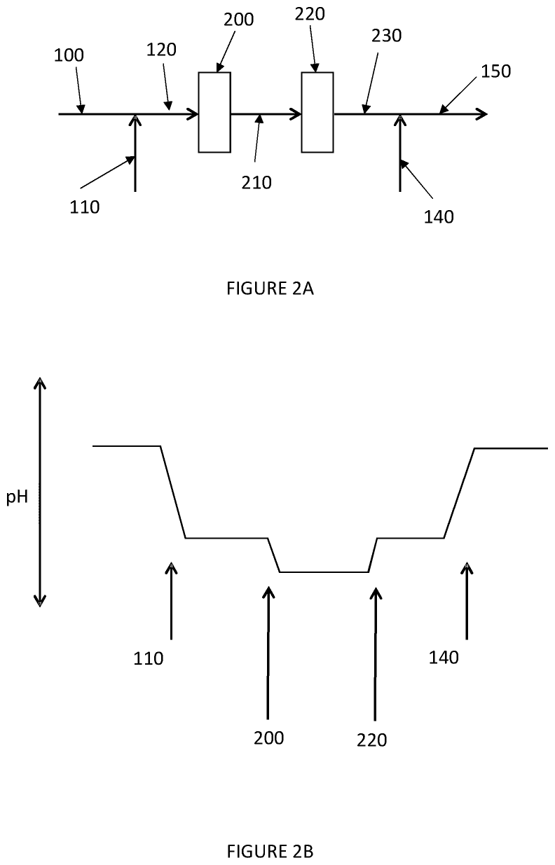

FIG. 2A depicts a schematic drawing of an apparatus for the treatment of a water stream comprising organic contaminants. In the related method of treating the water stream 100, the water stream 100 is mixed with an acid 110 to form a combined stream 120. Combined stream 120 is then fed to an anode compartment 200 of an electrochemical cell, wherein upon application of an anodic current, at least a portion of the organic contaminants in combined stream 120 is oxidised.

The applicants have found that, in addition to this oxidation reaction, the anode compartment also acts to lower the pH of the combined stream 120 by the production of protons, forming acidified stream 210. The acidified stream 210 is then fed to the cathode compartment 220, in which hydroxide ions are produced on the application of a cathodic current. This raises the pH of the acidified stream 210 to form part-treated stream 230, which matches the pH of the combined stream. Part-treated stream 230 is subsequently mixed with base 140 to neutralise the acid added initially to form treated stream 150, which possesses a pH equal to that of the initial water stream 100.

The variation in pH throughout this process is depicted FIG. 2B, which shows the pH of the water stream 100 being reduced by the addition of the acid to give a lower pH combined stream 120. The pH of the combined stream 120 is lowered by the action of the anodic current, forming acidified stream 210. The pH of the acidified stream 210 is raised back to the pH of the combined stream 120, forming part-treated stream 230. The pH of the part-treated stream is then raised back to the initial pH of the water stream 100 to form the treated stream 150.

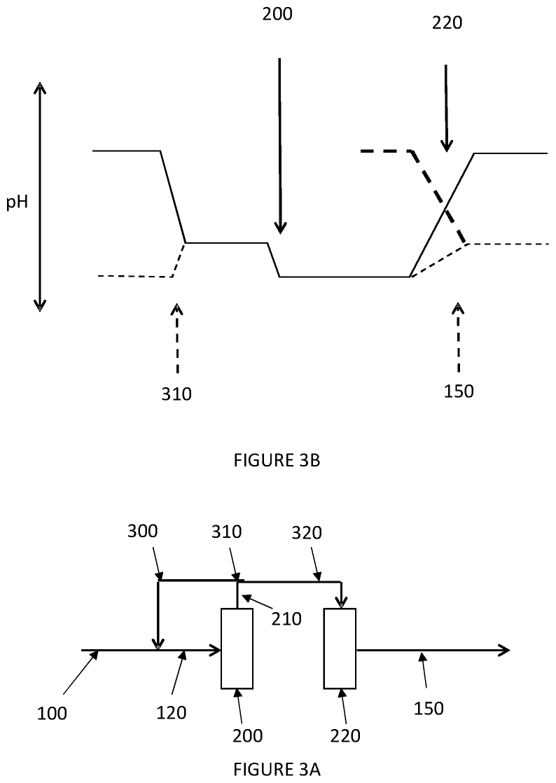

FIG. 3A depicts a schematic drawing of an apparatus for the treatment of a water stream comprising organic contaminants according to the present invention. In the related method of treating the water stream 100, the water stream 100 is mixed with a recycle stream 300, which has a low pH, in a first ratio to produce a combined stream 120 of a desirable, intermediate pH.

The combined stream 120 is then fed to anodic compartment 200 in which the combined stream 120 is exposed to an anodic current to oxidise at least a portion of the organic contaminants and add further protons to acidify the combined stream 120, producing acidified stream 210. The acidified stream 210 is fed to flow dividing means 310, where it is divided according to a second ratio into the recycle stream 300 (which is returned for mixing with the water stream 100) and a finishing stream 320.

The finishing stream 320 is then fed to the cathode compartment 220, where sufficient hydroxide ions are produced to substantially neutralise the finishing stream 320 to the extent that its pH is equal to that of the water stream 100, converting it to treated stream 150. The anode compartment 200 and the cathode compartment 220 may be separated by a semi-permeable, non-conductive separator, which allows the flow of electrical current but hinders the flow of ions such that hydrogen ions created in the anode compartment 200 are not able to recombine with hydroxide ions generated in the cathode compartment 220. Before the hydrogen ions and hydroxide ions are allowed to recombine to neutralise the stream, the hydrogen ions can be advantageously used to alter the pH of the stream to provide advantageous effects as described herein. Previously, there was no realisation of the ability to use the altered pH of the stream to provide any advantages in the system.

The variation in pH throughout this process is depicted FIG. 3B, which shows the pH of the water stream 100 being reduced by mixing with the lower pH recycle stream 310 to form intermediate pH combined stream 120. The pH of the combined stream 120 is lowered by the action of the anodic current, forming acidified stream 210.

The pH of recycle stream 300, split from the acidified stream 210, is raised a small amount by mixing with water stream 100. The pH of the treated stream, split from the acidified stream 210, is raised significantly in the cathodic compartment 220 to produce treated stream 150, the pH of which matches that of the water stream 100.

It can be seen that, with the anodic current and cathodic producing equal amounts of protons and hydroxide ions, the overall pH change induced by the method is zero and the process input and output (i.e. the water stream 100 and treated stream 150) have substantially the same pH. In addition, by careful management of the process parameters (e.g. the first and second ratios and the anodic and cathodic currents) the pH values of streams within the process may be controlled such that the pH of the combined stream 120 in the anode compartment 200 is optimised for the anodic oxidation reactions occurring within. This maximises the efficiency of the electrochemical water treatment step, while removing the need to add acids and bases to the streams.

Typically the first ratio is selected such that the mass flow of the recycle stream 310 is greater than that of the water stream 100, thereby effecting a large downward shift in pH on forming the combined stream 120.

Typically the second ratio is selected such that the mass flow of the finishing stream 320 is lower than that of the recycle stream 310.

Typically the anodic and cathodic currents are matched to produce equal protons and hydroxide ions at equal rates.

In typical operation, the first and second ratios are selected such that the mass flow through the anode compartment (i.e. the combined stream 120, which comprises the water stream 100 and recycle stream 300) is greater than the mass flow through the cathode compartment (i.e. the finishing stream 320). The anodic and cathodic currents are selected such that protons are produced in the anode compartment 200 at the same rate as hydroxide ions are produced in the cathodic compartment 220. Under these conditions, in any given time period, the protons produced in the anode compartment 200 are dispersed in the relatively large volume of the combined stream 120 which has passed through the anode compartment 200 in the time period, while the same number of hydroxide ions which are produced in the cathode compartment 220 are dispersed in the relatively small volume of the finishing stream 320 which has passed through the cathode compartment 220 in the time period. This results in a small pH decrease on conversion of the combined stream 120 to the acidified stream 210 and a large pH increase on conversion of the finishing stream 320 to the treated stream 150.

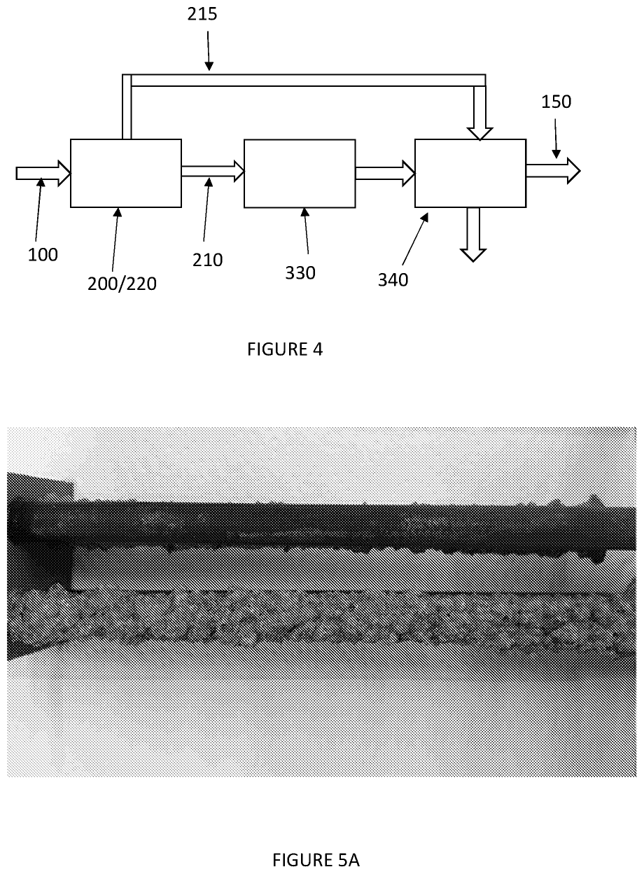

FIG. 4 depicts another embodiment similar to that depicted in FIG. 3, but with the additional of another water treatment unit. Whilst this figure does not depict the recycling of a portion of the acidified stream 210 back into the water stream 100, it will be appreciated that this may be present. The water stream 100, which may have been mixed with a portion of acidified stream 210, is passed into the electrochemical treatment unit comprising an anode compartment 200 and a cathode compartment 220. The acidified stream 210 from the anode compartment 200 is passed to the other water treatment unit 330. The other treatment unit 330 may be an ion exchange treatment unit, an activated carbon column, an electrocoagulation unit, or an electro-Fenton treatment unit. In the present exemplary embodiment, the unit may be an electrocoagulation unit. Since the acidified stream 210 has been passed into the electrocoagulation unit 330, metal ions are dissolved from the anode electrode, but precipitation is avoided due to the acidity of the stream. After passing through the electrocoagulation unit 330, the stream may be provided to a mixer 340 in which it is mixed with an alkaline stream 215 taken from the cathode compartment 220 of the electrochemical treatment unit. This neutralises the streams and results in precipitation of suspended ions. Where the original water stream 100 comprised phosphate, this precipitate may be ferric phosphate, which can be collected and sold. The treated stream 150 may be recovered or discharged.

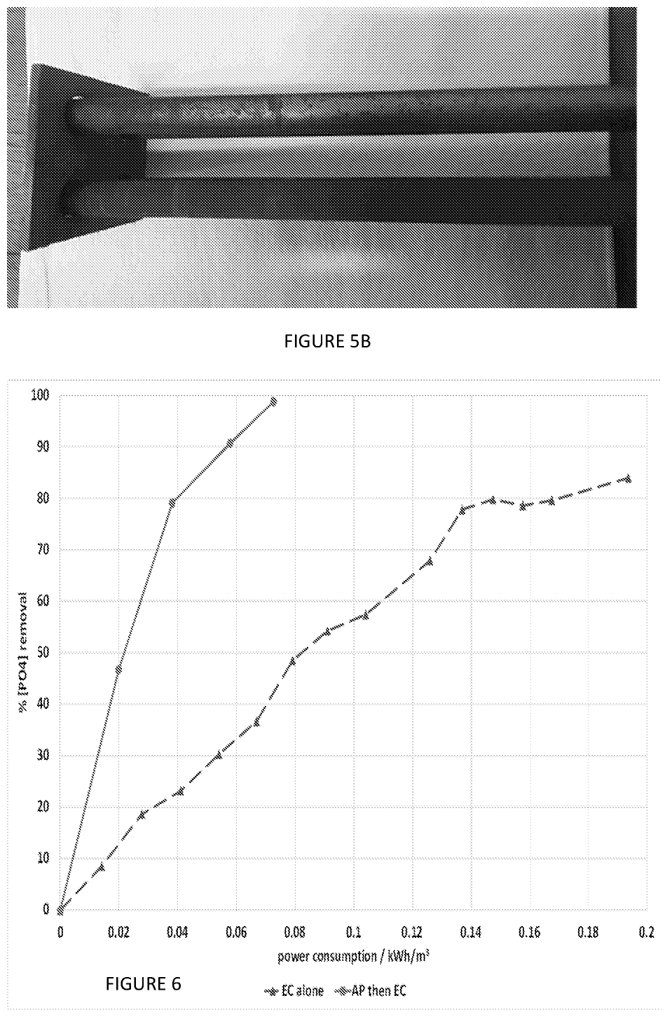

FIG. 5A depicts the electrodes of an electrocoagulation treatment unit under conventional operation and FIG. 5B depicts the electrodes of the same electrocoagulation unit operated under identical operating conditions with the exception that the electrodes of FIG. 5B are from when the electrocoagulation unit is included in a system as shown in FIG. 4. It can be seen that the provision of the acidified stream to the electrocoagulation system eliminates the build-up of precipitates on the electrodes. FIG. 6 is a graph showing the comparison of the effectiveness of phosphate removal of the combination of the process of the present invention (AP then EC) and just electrocoagulation alone. The combined process provides for much more effective phosphate removal, even at much lower power consumption. For example, the combined process can remove 80% of total phosphates present at a power consumption of 0.04 kWh per cubic metre whereas electrocoagulation by itself requires around four times the power consumption.

Table 1 below also demonstrates the advantage of the combined system over electrocoagulation by itself.

TABLE 1

| | | |
|---|---|---|
| EC | | EC power |
| current | [PO4]/ppm | consumption |

| Expt | A/m2 | initial | final | kWh/m3 |
|---|---|---|---|---|
| EC | 27 | 5.05 | 0.81 | 0.1935 |
| AP then EC | 43 | 4.91 | 0.12 | 0.0736 |

It can be seen that for the same voltage, a higher current passes through the stream which has been acidified in the combined process and the amount of phosphate removal is much improved.

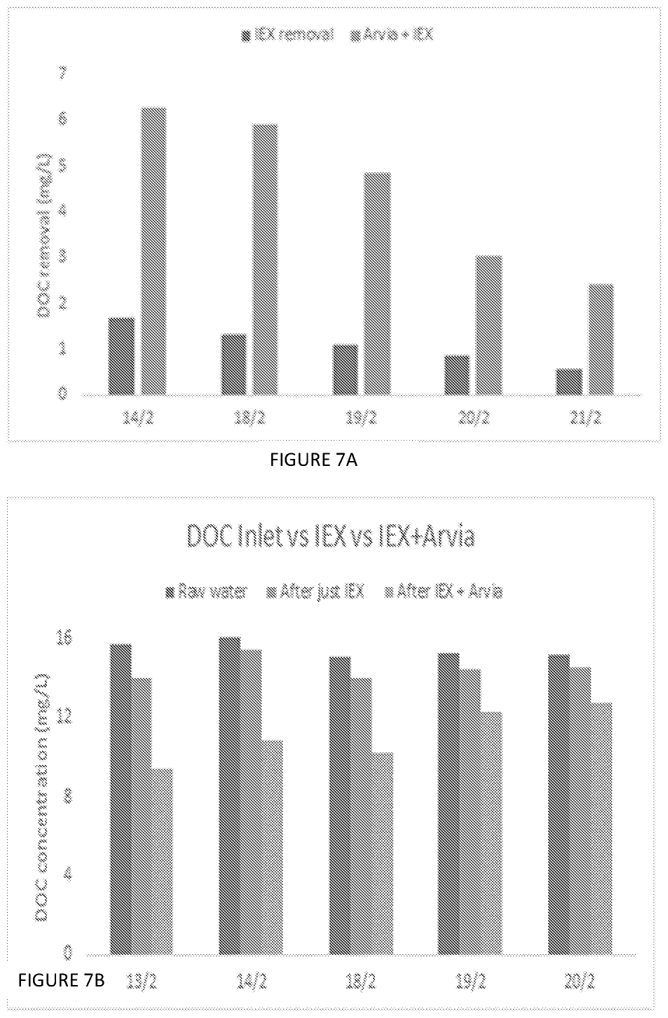

FIG. 7A compares the removal of dissolved organic carbon (DOC) from a sample using ion exchange resin alone and using the combined process according to an embodiment of the present invention. The bars relating to the ion exchange process alone (the shorter left hand bar of each pair of bars) demonstrate that the amount of DOC removed is far less when ion exchange alone is used and much greater (the taller right hand bar of each pair of bars) when the combined process is used thereby demonstrating a synergistic effect. The rate of removal decreases over time as the ion exchange resin material is exhausted.

FIG. 7B compares the DOC concentration of the raw water (left bar of each group of three), the concentration after only using ion exchange resin (centre bar of each group of three), and the concentration after the combined process according to embodiments of the present invention (right bar of each group of three). Again, the combined process demonstrates an unexpected improvement over what would be expected by simply combining the two individual processes, thereby indicating an unexpected synergistic effect. This is on the basis that ion exchange and the electrochemical oxidation process of the present invention each are expected to reduce COD levels by ten to fifteen percent, whereas combines, they recued COD levels by significantly more than the 20-30% as may be expected. Overtime, the ion exchange resin is exhausted resulting in decreased performance over time, but the combined process still shows better COD removal then even fresh ion exchange material alone.

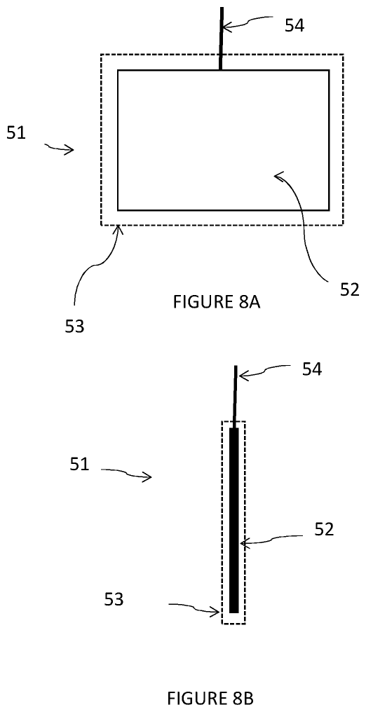

FIGS. 8A and 8B show current feeder 51 according to the fourth aspect of the present invention. The current feeder 51 comprises a conductor 52 and an envelope 53 comprising a porous separator material. Also shown is the optional electrical connection means 54 which allows the current feeder to be connected to an electrical circuit. The electrical connection means 54 may form part of the current feeder 51 or may form part of the electrical circuit (not shown). In the embodiment depicted in FIG. 8, the envelope 53 surrounds the conductor 52, but it will be appreciated that at least a portion of the conductor 52 may protrude from the envelope 53. Further, the conductor 52 is depicted as a solid, planar sheet, but it will also be appreciated that the conductor 52 does not necessarily have to be solid. The porous separator material comprising the envelope 53 is preferably non-conductive.

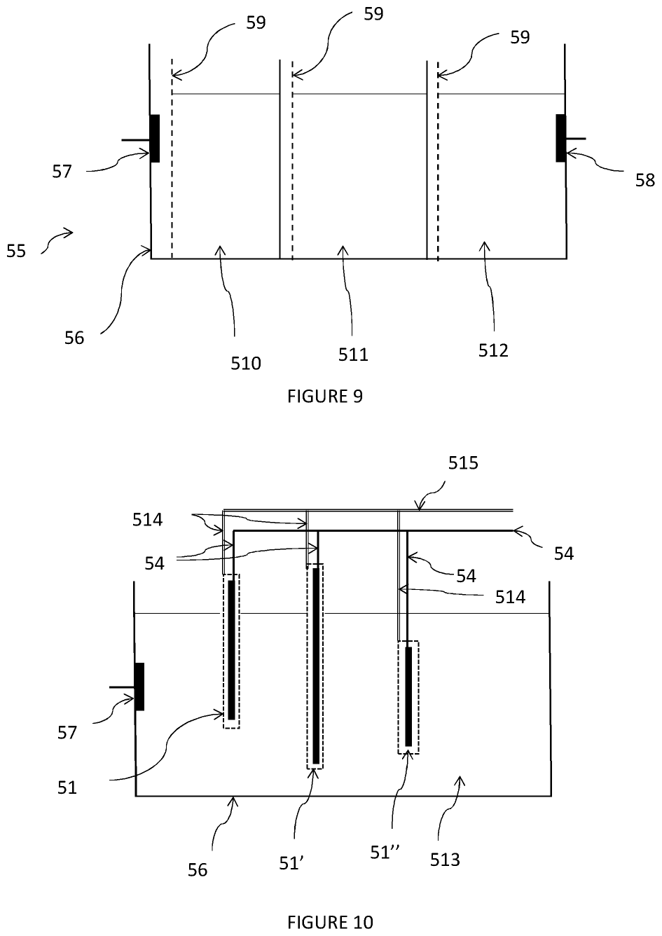

FIG. 9 shows an electrochemical cell 55 which does not utilise the current feeders according to the first aspect of the present invention. The cell 55 comprises a tank 56 having current feeders 57, 58. The cell 55 depicted in this figure comprises three separate beds of adsorbent material 510, 511, 512 which are separated by porous separators 59, although it will be appreciated that a tank having fewer or more beds is also possible. The porous separators 59 are sealed such that adsorbent material in each of the beds 510, 511, 512 is unable to pass into adjoining beds as this could lead to a short circuiting of the system. Since the porous separators 59 need to be fixed to the tank 56, it is not possible for them to be moved without great difficulty.

In use, the contaminated aqueous liquid to be treated enters the tank 56 via an inlet (not shown). As the liquid passes through the beds of adsorbent material 510, 511, 512, contaminants, such as microorganisms and organic compounds, contained within the liquid adsorb to the surface of the adsorbent material in the adsorbent beds 510, 511, 512. Thus, the amount of contamination in the liquid is reduced. An electrical current is passed between the current feeders 57, 58. This results in a current passing through the beds of adsorbent material 510, 511, 512. A portion of the current passes through the liquid, but a larger proportion of the current passes through the adsorbent material as its electrical conductivity is much higher. The passage of the electric current through the adsorbent material results in the electrochemical destruction of the adsorbed contaminants, which in turn results in electrochemical regeneration of the adsorbent material. The electrochemical regeneration occurs when the adsorbed contaminants are destroyed, usually by oxidation, and are broken down into carbonaceous gases. For example, where a microorganism is adsorbed on the surface of the adsorbent, the current may pass directly through the microorganism resulting in destruction of the microorganism. In addition, the localised increase in hydrogen ions during the oxidation of adsorbed organic and water may lower the pH and thereby damage, destroy, or disrupt the adsorbed microorganism. Further, in cases where chloride ions are present, an oxidised chloride species may be generated by the current and this species may directly chlorinate the adsorbed microorganism. Similarly, adsorbed organic molecules may also be broken down by similar processes of direct electron transfer, hydroxyl radical oxidation or mediated/indirect oxidation. The carbonaceous gases are able to desorb from the adsorbent material thus providing a surface on the adsorbent material to which further contaminants may adsorb. Thus, electrochemical regeneration of the adsorbent material allows further contaminants to be adsorbed from the liquid stream and subsequently destroyed. The treated liquid is able to pass out of the tank 6 via an outlet (not shown) for further treatment, recovery, or discharge.

In particular, the bed of adsorbent material next to the positive electrode behaves as an anode and adsorbed organics are oxidised and then released in the form of carbonaceous gases and water. The negative electrode behaves as a cathode and the water next to this electrode is reduced. The produced gases, in particular hydrogen, are released through the top of the tank 56 and are mixed with the carbonaceous gases also released. Following adsorption and subsequent electrochemical regeneration of the adsorbent material, which results from the electrochemical destruction of adsorbed contaminants, the treated liquid then exits the tank 56. The treated liquid may be sufficiently clean to be recovered for re-use. However, if the treated liquid still contains unwanted contaminants, in particular organic contaminants, it may be recycled back to the tank 56, or it may be passed to a further treatment reservoir for further treatment.

In use, the liquid may flow through the tank 56 and beds of adsorbent material 510, 511, 512 continuously or intermittently. In addition, the electric current may be passed through the liquid and adsorbent material continuously or intermittently.

Where the liquid passes through the tank 56 continuously, the flow rate of the liquid may be adjusted such that substantially all of the organic contaminants are removed from the water by the time the water passes out of the tank 56. Similarly, when the liquid passes through the reservoir 52 intermittently, the dwell time is adjusted such that substantially all of the organic contaminants are removed from the water before the water passes out of the outlet 54.

The magnitude and direction of the current may be selected depending on the circumstances. For example, where the liquid to be treated is heavily contaminated, a larger current may be required. In addition, the polarity of the current feeders may be such that the adsorbent beds 510, 511, 512 are cathodic. The adsorbent beds 510, 511, 512 may be cathodic in cases where reduction, rather than oxidation, of the contaminant is required. For example, the contaminated liquid may contain bromate ions and it is desirable to reduce the bromate ions to bromide. The current may also be reversed in order to remove and scaling that has built up on the current feeders.

The adsorbent bed may serve to act as a filter to filter out insoluble materials entrained in the water. The entrained organic contaminants are adsorbed onto the surface of the adsorbent material and the adsorbent material is electrochemically regenerated by the passage of current through the adsorbent material. In addition, there may be a disinfectant precursor species present in the liquid to be treated. The disinfectant precursor species may be in solution in the liquid to be treated or may be added. A portion of the current flowing between the electrodes will pass through the liquid and convert the disinfectant precursor species into a disinfectant species. In particular, the disinfectant precursor species may comprise chloride ions and the disinfectant species may be an oxidised chloride species. The disinfectant species will diffuse throughout the liquid to be treated and provide an additional disinfectant action. Once the liquid has passed through the chamber, preferably it will be substantially free of organic contaminants and suitable for use. Generation of oxidised chlorine species can produce residual disinfection potential which will maintain an amount of water suitable for storage prior to use.

FIG. 10 depicts an electrochemical cell which is similar to the cell 55 depicted in FIG. 9 and which operates in a similar way. As such, the means of operation described in respect of FIG. 9 are applicable to the apparatus depicted in FIG. 10. Common features are given the same reference numerals. The key difference between the cell depicted in FIG. 10 and the cell depicted in FIG. 9 is that the cell in FIG. 10 comprises current feeders according to the fourth aspect of the present invention. This allows there to be a single bed of adsorbent material 513 rather than three separate beds 510, 511, 512 as depicted in FIG. 9, which allows for easier replacement of the adsorbent material when required.

The current feeders 51, 51′, 51″ shown in FIG. 10 are depicted as being of different sizes, although it will be appreciated that the current feeders may be of the same size. The current feeders 51, 51′, 51″ are each connected to an electrical circuit 54a via electrical connection means 54. The current feeders 51, 51′, 51″ also comprise vents pipes 514 connected to a common hydrogen rail 515 via which hydrogen is able to escape. The current feeders 51, 51′, 51″ may also comprise at least one opening through which liquid may escape from the inside of the envelope 53 back into the tank 56. This may be required as application of an electric field will allow liquid to transfer through the porous separator into the inside of the envelope 53 through electro-osmosis caused by an increase in the concentration of hydroxide ions within the envelope 53. The opening allows this liquid to escape back into the liquid being treated where it will modify its pH back to its initial starting level. Thus, the system may auto-correct the drop in pH caused by the generation of hydrogen ions in the anodic bed when electro-osmosis causes water to enter the envelope and overspill back into the anodic bed bringing hydroxide ions to neutralise the hydrogen ions.

In FIG. 10, a current feeder 57 is in electrical connection with the bed of adsorbent material 513. This current feeder may optionally be separated from the current feeders 51, 51′, 51″ through placement in a non-porous, insulating zone of the reservoir effectively separating the second current feeders from the current feeder 57 in order to force the current into the adsorbent material which is around 4 orders of magnitude more conducting that the aqueous liquid to be treated. Liquid to be treated is passed through the bed of adsorbent material 513. The current feeders 51, 51′, 51″ which are contained within an envelope of porous separator material are able to be inserted into the bed of adsorbent material 513 and the number, spacing and sizes of the current feeders 51, 51′, 51″ can be varied depending on the requirement of the system. As each current feeder 51, 51′, 51″ is at the same potential as it is connected to the power supply via a common connection and the bed is maintained at a uniform potential through the insertion of a current feeder 57, the potential difference across the separator is the same, so the current density across the separators will be the same. Thus, the separators can be of different sizes and there is no need for them to be equally spaced. If greater treatment capacity is required then more current feeders can be added to the adsorbent bed 513. As mentioned above, this arrangement also allows for auto-pH correction as the hydroxide ions generated by the current feeders 51, 51′, 51″ can neutralise the hydrogen ions produced in the adsorbent bed through either passing through the porous separator 53 or by overflowing the top of the semi/selectively permeable separator 53 through the action of electro-osmosis.

A further benefit of this system is that it makes maintenance much simpler and does not necessitate the shutting down of the unit to remove one of the current feeders. Removing a current feeder 51, 51′, 51″ is straightforward as it can be simply uncoupled and pulled out of the bed 513. A new current feeder can then be inserted and coupled to the power supply. All the other assemblies can continue to operate whilst this operation is on-going. Similarly, the current feeder 57 for the bed can be removed and a new one added without shutting down the cell (if there are more than one current feeder). The fact that there is no need for seals and no need for exact position makes replacement a much simpler task.

It should also be appreciated that there will be limited opportunity for the build-up of biofilms within the system as the electric current passing through the adsorbent bed has been shown to kill micro-organisms.

If a higher flow rate is required through the system, then a further one or more tanks may be added in series. This will keep the current constant and will increase the voltage of the system. This is different to the conventional approach where it is usual to add cells in series (increasing the voltage) and then a further stack is added in parallel (increasing the current).

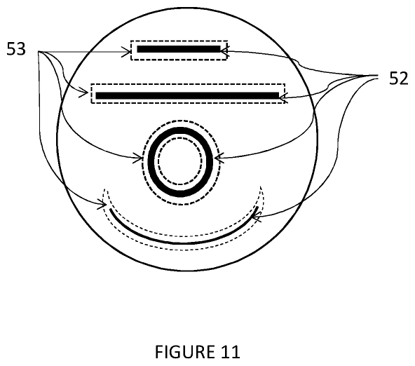

It should be appreciated that the shape of this apparatus is not limited to systems comprising a tank and any shape of vessel could be used. For example, FIG. 11 depicts a cross-sectional view of a pipe in which current feeders according to the present invention have been inserted.

As can be seen from FIG. 11, the current feeders may be in any shape. In this example, the current feeders are planar, u-shaped/semi-circular, and circular, although it will be appreciated that this is intended to show examples of possible shapes of current feeders and is not intended to be limited to the particular configuration or shapes depicted therein. Since the conductors are contained within a porous, non-conductive envelope, there is no risk of short circuiting, and, in operation, the current will be forced to pass out of the conductive adsorbent material before passing through the non-conductive porous envelope 53.

There may be suitable meshes (not shown) in the pipe in order to retain the adsorbent material adjacent the current feeders. If the pipe itself is conductive and it is safe to do so, the pipe itself may be used as a current feeder. Alternatively or additionally, there may be provided a current feeder (to be used as the anode) within the bed of conductive adsorbent material.

A number of experiments were undertaken to investigate the performance of the apparatus according to the fifth aspect of the present invention compared to known apparatus.

### EXPERIMENTAL

### Experiment 1

An experiment was undertaken to investigate the oxidation of 2, 3-dichlorophenol using a treatment system according to the present invention.

25 litres of 2,3-dichlorophenol at a concentration of around 550 ppm was treated in a system comprising around 2.6 kg of NYEX. The NYEX had been presaturated with 2,3-dichlorophenol. The liquid was recycled and a flow rate of around 4 litres per hour and a current of around 1 Amp were used. Four current feeders according to the first aspect of the present invention were used. The material used as the porous separator was Daramic. After around 5 days of treatment, it was found that around 65% of the 2,3-dichlorophenol has been destroyed.

### Experiment 2

A further experiment was undertaken to compare the effectiveness of Nylon as the porous separator material instead of Daramic.

The experimental parameters were the same as Experiment 1, although the 2,3-dichlorophenol was at a concentration of around 600 ppm. It was found that Nylon required around 33% less energy to destroy an equal amount of the 2,3-dichlorophenol due to a lower voltage requirement and a higher amount of the contaminant destroyed. When Nylon was used as the porous separator material, around 16% less energy was required to treat an equal amount of water when compared with Daramic.

### Experiment 3

An experiment was undertaken to compare the performance of a system according to the second aspect of the present invention, which include the current feeders according to the first aspect of the present invention, against a system of the prior art.

A test solution comprising 2,3-dichlorophenol at a concentration of 60 ppm was passed through two sets of apparatus at a flow rate of 8 litres per hour with a current of 1 Amp. The porous separator material used in both cases was Daramic. The liquid was not recycled and made one pass through the apparatus. The mass of NYEX used was around 2.6 kg. The treatment was run for 30 hours.

The total amount of 2,3-dichlorphenol removed from the known apparatus and the apparatus according to the present invention was quite similar. However, the apparatus according to the present invention operated at a much lower voltage to achieve the same result, and the total energy required to destroy 1 kg of contaminant was around 36% lower in the apparatus of the present invention when compared with the system of the prior art. In particular, the apparatus of the present invention destroyed 28% of the contaminants with the prior art system destroyed 31%. However, the ratio of energy input to volume treated (kWh per cubic metre) for the apparatus according to the present invention was 0.61, whereas it was 1.0 for the prior art system. As such, in addition to the advantages described previously, the apparatus according to the present invention offers considerably better efficiencies than known systems.

### Experiment 4

The effect of the number of current feeders according to the first aspect of the present invention in a system was also investigated.

Using the same parameters of Experiment 3, a comparison between the use of one and two current feeders was made. The apparatus comprising a single current feeder according to the present invention destroyed 17.5% of the contaminant and the system comprising two current feeders destroyed 28%. The ratio of energy input to volume treated (kWh per cubic metre) for the apparatus with one current feeder was 1.5 and was 0.61 for the system having two current feeders. As such, the use of multiple current feeders increases the efficiency of the system and demonstrates that the ability to readily increase the number of current feeders is advantageous.

### Experiment 5

A further investigation into the effect of the number of current feeders in a system was conducted.

25 litres of 2,3-dichlorphenol at a concentration of around 500 ppm was used. The test solution was recycled at a flow rate of 4 litres per hour through a bed of around 2.6 kg of NYEX using a current of 1 Amp. The NYEX was presaturated with 2,3-dichlorophenol. The experiment was run for 6 days.

As with Experiment 4, it was found that the greater number of current feeders was associated with a lower voltage and a corresponding reduction in the amount of energy required to remove a given amount of contaminant. In particular, the amount of energy required to destroy one kilogram of contaminant was around 50% higher when using two current feeders (24.3 kWh m⁻³) compared to using four current feeders (17.1 kWh m⁻³), and around 130% higher when using one current feeder (36 kWh m⁻³) compared to using four current feeders (17.1 kWh m⁻³).

### Experiment 6

The previous experiments were conducted in a generally rectangular tank and a further experiment to investigate the effect of using a tubular shaped tank was conducted.

A test solution comprising 60 ppm of 2,3-dichlorophenol was flowed through a tubular cell at a flow rate of 23.5 litres per hour using a current of 2.7 Amps. The test solution was passed through around 7.6 kg of NYEX and was not recycled. A total of five current feeders according to the first aspect of the present invention were used. The current feeders were of varying sizes, but with a surface area totaling around 4160 square centimetres. The test was run for 30 hours. This was compared against a tubular system not comprising the current feeders according to the present invention as well as against a known system using a rectangular cell.

Again, the apparatus according to the present invention was more efficient than the other systems, requiring around 25% less energy to destroy an equal amount of contaminant and 50% less energy to treat an equal volume of water. In particular, the system of the present invention had a ratio of energy used to volume treated (kWh m³) of 0.47, which compares favourably with 0.70 for a tubular system using conventional current feeder setup and 1.0 using a known rectangular system using known current feeders.

In summary, the current feeders according to the present invention are particularly suitable for use in systems comprising a bed of conductive adsorbent material as they allow greater flexibility with regards to the number and placement of the current feeders. The present invention allows for removal, addition, and/or replacement of current feeders when the system is in use without the need to stop the system. It has also been found that using the current feeders according to the present invention provides for effective removal of contaminants from an aqueous medium but with significantly decreased energy requirements.

The experiments also indicated how the current feeders according to the present invention could be used to improve the efficiency of existing system without requiring expensive and difficult changes to be made to the existing apparatus. As such, one particular application could be in retro-fitting existing tanks with the current feeders according to the present invention. It will be appreciated that scale up of this system will be very straight forward. Thus, it is readily possible to adapt the system to take account of different operational needs.

The apparatus and methods of the present invention are suitable for a wide variety of application. For example, the apparatus and methods of the present invention are also suitable for other applications, including in the treatment of drinking water, hot tubs, air conditioning units, aquaculture/aquaponics, swimming pools, marine applications, industrial effluent treatment, disinfection applications, and many others.

The apparatus of the present invention is simpler than known apparatus and may be made from ready available starting materials without the need for specialised fabrication.

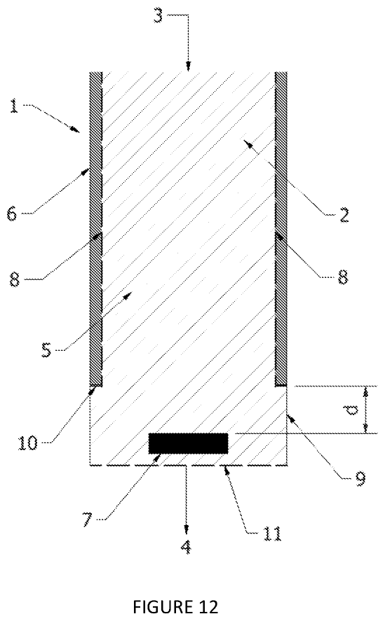

FIG. 12 shows apparatus 1 according to the thirteenth aspect of the present invention. The apparatus comprises a tubular treatment reservoir 2 having an inlet 3 for contaminated aqueous liquid and an outlet 4 for treated liquid. Within the tubular treatment reservoir 2 is a bed of adsorbent material 5. A first current feeder 6 and a second current feeder 7 are coupled to a source of electrical power (not shown). A porous separator 8 is provided and is disposed between the bed of adsorbent material 5 and the first current feeder 6. In this figure, the first current feeder 6 is shown as a tube surrounding the porous separator 8, which defines the treatment reservoir 2. The tubular treatment reservoir 2 comprises a further portion 9 which is non-porous and insulating. The further portion 9 separates the first current feeder 6 from the second current feeder 7 by a distance d. By having the non-porous, insulating portion 9 between the first current feeder 6 and the second current feeder 7, the current is forced into the bed of adsorbent material 5, resulting in the bed having a more even charge distribution as would otherwise be the case. The second current feeder 7 is depicted as a planar electrode, but could also be any shape including annular, similar to the first current feeder 6. In such an embodiment, at least one of the first and second current feeders 6, 7 could be formed of metallic pipes, such as stainless steel pipes, and be separated by the non-porous, insulating portion 9. It has been surprisingly found that even when used as an anode stainless steel does not corrode as would be expected. Without wishing to be bound by scientific theory, it is believed that because it is acting as a current feeder with the electrons feeding directly from the stainless steel to the NYEX bed (the conductive adsorbent material) and the NYEX bed acts as the electrode and this is where oxidation occurs such that the stainless steel is protected. As such in any embodiment described herein, the anodic current feeder may be stainless steel when it is in electrical contact with a bed of conductive adsorbent material. There is a seal 10 at the bottom of the porous separator 8. The seal may be made by any suitable means and from any suitable material. For example, the seal may be made from silicone, although any material able to withstand the environment in the apparatus 1 could be used. The porous separator 8 is not sealed at the top in order to allow any gaseous products generated in the space between the porous separator 8 and the first current feeder 6 to leave the space. At the bottom of the treatment reservoir, there is a mesh or filter 11 to retain the bed of adsorbent material 5 in place, but allowing treated liquid to pass out of the apparatus 1 via outlet 4. It will also be appreciated that the flow could be reversed such that the cell operates in an upflow mode.

In use, the contaminated aqueous liquid to be treated enters the apparatus 1 via the inlet 3. As the liquid passes down through the bed of adsorbent material 5, contaminants, such as microorganisms and organic compounds, contained within the liquid adsorb to the surface of the adsorbent material in the adsorbent bed 5. Thus, the amount of contamination in the liquid is reduced. An electrical current is passed between the first and second current feeders 6, 7 respectively. This results in a current passing through the bed of adsorbent material 5. A portion of the current passes through the liquid, but a larger proportion of the current passes through the adsorbent material as its electrical conductivity is much higher. The passage of the electric current through the adsorbent material results in the electrochemical destruction of the adsorbed contaminants, which in turn results in electrochemical regeneration of the adsorbent material. The electrochemical regeneration occurs when the adsorbed contaminants are destroyed, usually by oxidation, and are broken down into carbonaceous gases. For example, where a microorganism is adsorbed on the surface of the adsorbent, the current may pass directly through the microorganism resulting in destruction of the microorganism. In addition, the localised increase in hydrogen ions during the oxidation of adsorbed organic and water may lower the pH and thereby damage, destroy, or disrupt the adsorbed microorganism. Further, in cases where chloride ions are present, an oxidised chloride species may be generated by the current and this species may directly chlorinate the adsorbed microorganism. Similarly, adsorbed organic molecules may also be broken down by similar processes of direct electron transfer, hydroxyl radical oxidation or mediated/indirect oxidation. The carbonaceous gases are able to desorb from the adsorbent material thus providing a surface on the adsorbent material to which further contaminants may adsorb. Thus, electrochemical regeneration of the adsorbent material allows further contaminants to be adsorbed from the liquid stream and subsequently destroyed. The treated liquid is able to pass out of the apparatus 1 via outlet 4 for further treatment, recovery, or discharge.

In particular, the bed of adsorbent material next to the positive electrode behaves as an anode and adsorbed organics are oxidised and then released in the form of carbonaceous gases and water. The negative electrode behaves as a cathode and the water next to this electrode is reduced. The produced gases, in particular hydrogen, are released through the top of the reservoir 2. The produced gases may be recovered, possibly for subsequent treatment. Following adsorption and subsequent electrochemical regeneration of the adsorbent material, which results from the electrochemical destruction of adsorbed contaminants, the treated liquid then exits the reservoir 2 via outlet 4. The treated liquid may be sufficiently clean to be recovered for re-use. However, if the treated liquid still contains unwanted contaminants, in particular organic contaminants, it may be recycled to the inlet 3 of the reservoir 2 through which it has passed, or it may be passed to a further treatment reservoir for further treatment. In use, the liquid may flow through the reservoir 2 and bed of adsorbent material 5 continuously or intermittently. In addition, the electric current may be passed through the liquid and adsorbent material 5 continuously or intermittently.

Where the liquid passes through the reservoir 2 continuously, the flow rate of the liquid may be adjusted such that substantially all of the organic contaminants are removed from the water by the time the water passes out of the outlet 4. Similarly, when the liquid passes through the reservoir 2 intermittently, the dwell time is adjusted such that substantially all of the organic contaminants are removed from the water before the water passes out of the outlet 4.

The magnitude and direction of the current may be selected depending on the circumstances. For example, where the liquid to be treated is heavily contaminated, a larger current may be required. In addition, the polarity of the current feeders may be such that the adsorbent bed 5 is cathodic. The adsorbent bed 5 may be cathodic in cases where reduction, rather than oxidation, of the contaminant is required. For example, the contaminated liquid may contain bromate ions and it is desirable to reduce the bromate ions to bromine.

The flow of liquid to be treated is generally downwards, namely from the top of the figure towards the bottom. The downward flow of the liquid and the weight of the particles comprising the adsorbent bed 5 results in the adsorbent bed 5 being slightly more compressed at the bottom when compared to the top.

While a generally downward flow of liquid to be treated is indicated in FIG. 12, the opposite arrangement can also be used. Thus, liquid to be treated could be admitted at the bottom of the reservoir 2 and withdrawn from the top of the reservoir 2. It is preferable that there is some sort of filter at the discharge point because of the proximity of the bed of adsorbent material 5. The direction of flow of the liquid through the reservoir 2 will be selected on the basis of the system requirements. Where the flow of liquid is generally downwards, it serves to slightly compress the bed of adsorbent material 5 and thus increase the conductivity of the bed 5. Since the conductivity is increased, this may reduce the voltage required to pass through the adsorbent bed 5 to regenerate the adsorbent and therefore lower power could be used. Alternatively, where the flow of the liquid is generally upwards, this has the opposite effect and spreads the bed of adsorbent material 5 out. This in turn decreases the conductivity of the bed 5 and increases the power requirements. However, the upward flow may serve to expel contaminants that are unable to be adsorbed to the adsorbent material. Where the liquid to be treated flows generally downwards, the adsorbent bed 5 may act as a particulate filter and any particles entrained in the liquid to be treated will tend to accumulate in the upper portion of the adsorbent bed. This may result in inhibition of the flow of liquid through the bed 5. By reversing the flow of the liquid to be treated, this may serve as a backwash to expel accumulated particles and other contaminants. If the upward flow is great enough and there is no mesh or filter in place to stop the adsorbent material exiting the reservoir, an upward flow may be used to remove at least a portion of the adsorbent bed 5 to create space for fresh adsorbent material to be added to the reservoir 2.

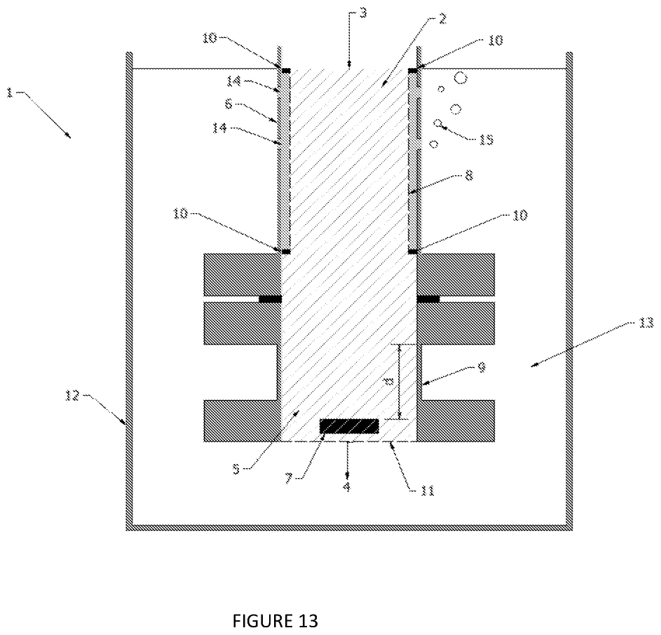

FIG. 13 depicts an embodiment of the apparatus according to the first aspect of the present invention. It is similar to the embodiment depicted in FIG. 12 and equivalent features are given the same reference numerals. In this embodiment, the apparatus is contained within a tank 12 containing a catholyte solution 13. The first current feeder 6, which may serve as the wall of the tubular treatment reservoir 2, has one or more holes 14 which allows for hydrogen to pass through and escape 15 and for catholyte to provide a conducting solution between the cathode and the separator. The porous separator 8 is sealed at the top and the bottom by seals 10. Hydroxide ions formed in the space between the porous separator 8 and the first current feeder 6 are able to enter the catholyte solution 13. The catholyte solution 13 may be flowed such that the original catholytes in the solution are flushed out. The catholytes increase the conductivity of the solution and therefore reduces the power requirements. However, due to the generated of hydroxide ions, the original catholytes may be flushed away, but the hydroxide ions generated will maintain the conductivity of the liquid. In this way, the process is self-sustaining and it is not necessary to continuously add additional catholytes. As with FIG. 12, the further portion 9 separates the first current feeder 6 from the second current feeder 7. In particular, the further portion 9 lengthens the shortest path which the current may take between the current feeders. This reduces the wear on the current feeders, in particular the second current feeder as the flow of current is more evenly distributed across the surface of the current feeder. In addition, the current is forced to take a longer path through the adsorbent material and/or liquid being treated. This ensures that there is equal electrochemical regeneration of the adsorbent material throughout the bed 5. This also ensures that the potential of the adsorbent bed is almost equal throughout the whole bed 5. Whilst there will always be a slight difference between the top and bottom of the bed, the presence of an insulating portion 9 to increase the distance between the two current feeders serves to spread the flow of current more evenly than would otherwise be the case.

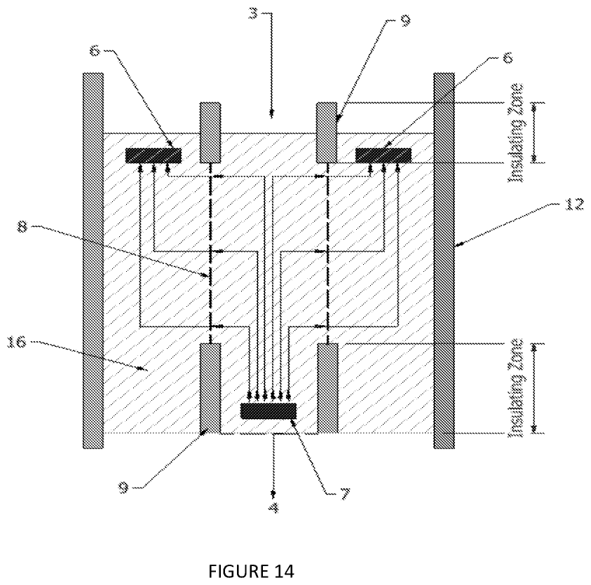

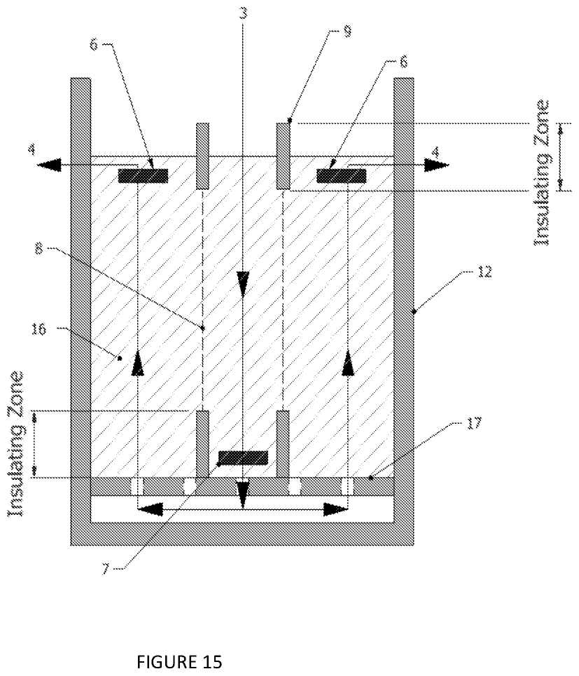

FIGS. 14 and 15 depict further embodiments of the invention according to the thirteenth aspect of the present invention. Again, equivalent features are given the same reference numerals as used in FIG. 12. The apparatus of FIG. 14 is similar to that of FIG. 13, except that there is a second bed of adsorbent material 16 on the outside of the porous separator 8 in addition to the bed of adsorbent material 5 within the tubular treatment reservoir 2. The apparatus of FIGS. 14 and 15 operates in the same way as the apparatus of FIGS. 12 and 13. The second bed of adsorbent material 16 serves to reduce the power requirements of the apparatus as it has a conductivity around four orders of magnitude greater than the surrounding liquid. As such, the current preferentially flows through the adsorbent material rather than the liquid. At the porous separator 8, the current is forced to exit the adsorbent material and enter the liquid in order to pass through the porous separator. When it reaches the other side of the porous separator 8, the current re-enters the adsorbent material. The passage of the current into and out of the adsorbent material results in oxidation of contaminants adsorbed to the adsorbent material and reduction of water to produce hydrogen. In FIG. 14, the liquid to be treated passes through the treatment reservoir 2 and out of the outlet 4. In FIG. 15, the liquid passes out of the outlet 4, but there is a connection with the liquid in the second bed of adsorbent material 16, such that the liquid exiting the outlet 4 is able to pass up through the second bed of adsorbent material 16.

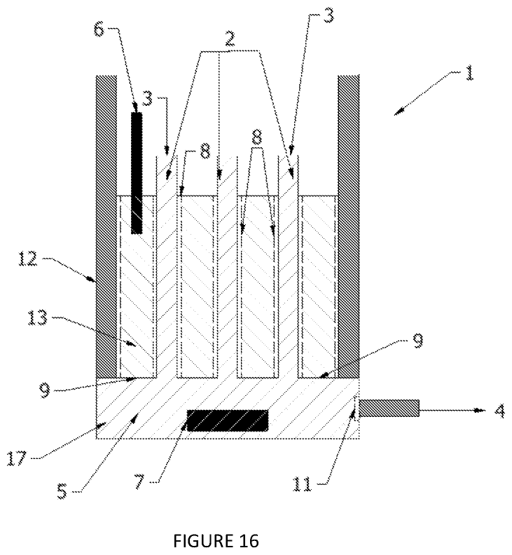

FIG. 16 depicts a further embodiment of the apparatus according to the thirteenth aspect of the present invention. In this embodiment, there is a plurality of treatment reservoirs 2 which are connected to a common chamber 17. The bed of adsorbent material 5 is continuous throughout the plurality of treatment reservoirs 2. Outside of the porous separators 8 is a catholyte solution 13 contained within tank 12. The first current feeder 6 is coupled to the catholyte solution 13 meaning that only a single connection is required, although it will be appreciated that more could be employed. The second current feeder 7 is located within the common chamber 17 in order to provide an equal charge to the adsorbent bed 5 in each of the treatment reservoirs 2. As with all embodiments according to other aspects of the present invention, there is a non-porous, insulating portion 9 separating the first and second current feeders 6, 7. Since the plurality of reservoirs 2 and the common chamber 17 are connected, it is convenient to remove and/or refill the adsorbent material at once and it is not necessary to empty or refill each reservoir 2 individually.

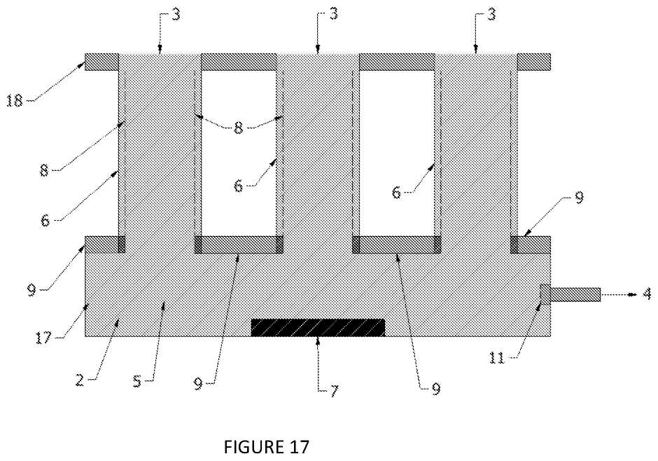

FIG. 17 depicts a further embodiment of the apparatus according to the thirteenth aspect of the present invention and also an embodiment of the apparatus according to the present invention. This embodiment is similar to the embodiment depicted in FIG. 12, although there is a plurality of tubular treatment reservoirs 2 and the first current feeders 6 are electrically connected to one another by a common plate 18. Since the common plate 18 is electrically conductive, it is possible for a single connection to the electrical power source to be used. In addition, instead of each treatment reservoir 2 having an individual second current feeder 7, these may be replaced by a single second current feeder 7 located in the common chamber 17 and in electrical connection with the bed of adsorbent material 5.

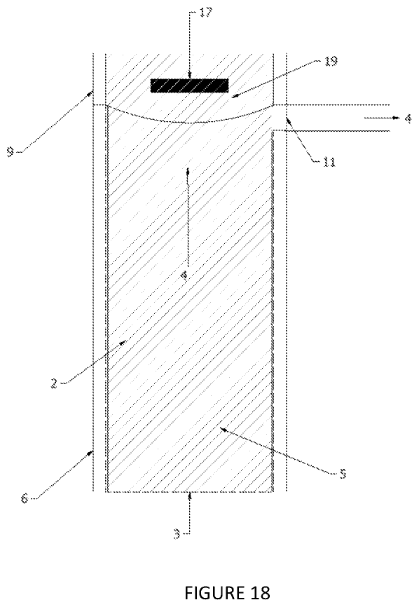

FIG. 18 depicts a further embodiment of the apparatus according to the thirteenth aspect of the present invention. In this embodiment, the flow of liquid to be treated is generally upwards through the bed of adsorbent material 5. In one embodiment of this arrangement, the second current feeder is at the top of the cell, where the liquid can flow past, over or through it. However, in addition the outlet for the liquid may be before the second current feeder 7. In this embodiment, the second current feeder does not come into contact with the liquid to be treated and the liquid to be treated is instead taken off via the outlet before coming into contact with the second current feeder 7. As such, there is a portion 19 of the adsorbent bed which is not surrounded by the liquid to be treated. As such, the portion 19 is dry. The treatment reservoir is filled with adsorbent material such that the adsorbent material is in electrical contact with the second current feeder 7. In this way, all of the current is passed into the adsorbent material and none is passed through the liquid to be treated. Again, this is to try to ensure that the bed of adsorbent material 5 is held at the same potential along its entirety.

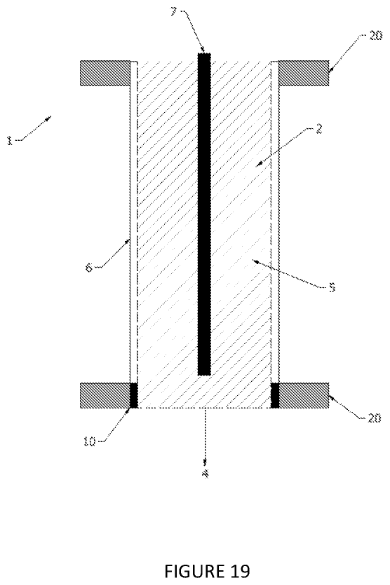

FIG. 19 depicts an apparatus according to the fourteenth aspect of the present invention. The apparatus comprises a tubular treatment reservoir 2. The treatment reservoir 2 is preferably substantially annular, although may be of any suitable shape. The reservoir 2 comprises an inlet 3 for liquid to be treated and an outlet 4 for treated liquid. The chamber 2 contains a bed 5 of adsorbent material. A first current feeder 6 and a second current feeder 7 are provided. The first current feeder 6 comprises the wall of the reservoir 2 and the second current feeder 7 is an elongate electrode located in the reservoir 2. The second current feeder 7 may be located substantially equidistant from the sides of the reservoir 2. Since the reservoir 2 is generally annular in horizontal cross-section, the distance between the second current feeder 7 and the wall of the reservoir 2 is the same all around. Therefore, the radial flow of current between the current feeders is equal on all sides of the second current feeder 7. A mesh or filter 11 is provided at the bottom of the reservoir 2 which allows for the liquid to pass through and out of the reservoir but which retains the adsorbent material comprising the bed 5 in the reservoir 2. There is also a porous separator 8 located between the bed of adsorbent material 5 and the first current feeder 6. The porous separator 8 stops the adsorbent material from coming into contact with the wall of the reservoir, which may be the first current feeder 6. The porous separator 8 may be a semi/selectively-permeable membrane. Where the porous separator 8 is a membrane, it is preferably non-conductive. The membrane prevents the solid adsorbent particles coming into contact with the cathode as this could result in electrons going directly from the cathode to the anode without passing through the liquid phase. In such a case, there would be no organic oxidation and no regeneration of the adsorbent. The membrane must allow the transfer of ions or electrons through it to complete the electric circuit. If the membrane is semi/selectively-permeable, it can restrict the passage of hydroxide ions, the constant reduction of water at the cathode would result in the catholyte becoming more alkaline, giving a higher conductivity and lower cell voltages.

Preferably, there is a low conducting liquid between the porous separator 8 and the first current feeder 6/wall of the reservoir 2. The space between the porous separator 8 and the wall/first current feeder 6 may be open at the top to allow hydrogen to escape.

The apparatus according to the fourteenth aspect of the present invention may comprise one or more flanges 20. The one or more flanges 20 may be located at the top and/or bottom of the wall of the reservoir 2. The flange or flanges 20 allow the apparatus to be readily connected into existing pipework.

In use, the method of operating the apparatus according to the fourteenth aspect of the present invention is largely identical to the method for operating the apparatus according to the thirteenth aspect of the present invention. The liquid to be treated is admitted to the reservoir 2 via inlet 3. As the liquid moves down the reservoir 2 through the bed of adsorbent material 5, entrained contaminants, such as microorganisms or organic compounds, are adsorbed onto the surface of the adsorbent material. Thus, the amount of contamination in the liquid is reduced. The adsorbent bed is electrochemically regenerated by passing a current through the bed. This is accomplished by the application of an electric voltage between the first current feeder 6 and the second current feeder 7. The electric voltage causes a current to flow between the current feeders. A portion of the current passes through the liquid, but a larger proportion of the current passes through the adsorbent material. The passage of the electric current through the adsorbent material results in the electrochemical destruction of the adsorbed contaminants. For example, where a microorganism is adsorbed on the surface of the adsorbent, the current may pass directly through the microorganism resulting in destruction of the microorganism. In addition, the localised increase in hydrogen ions during the oxidation of adsorbed organic and water may lower the pH and thereby damage, destroy, or disrupt the adsorbed microorganism. Further, in cases where chloride ions are present, an oxidised chloride species may be generated by the current and this species may directly chlorinate the adsorbed microorganism. Similarly, adsorbed organic molecules may also be broken down by similar processes of direct electron transfer, hydroxyl radical oxidation or mediated/indirect oxidation.

In particular, the bed of adsorbent material next to the positive electrode behaves as an anode and adsorbed organics are oxidised and then released in the form of carbonaceous gases and water. The negative electrode behaves as a cathode and the water next to this electrode is reduced. The produced gases, in particular hydrogen, are released through the top of the reservoir 2. The produced gases may be recovered, possibly for subsequent treatment. Following adsorption and subsequent electrochemical regeneration of the adsorbent material, which results from the electrochemical destruction of adsorbed contaminants, the treated liquid then exits the reservoir 2 via outlet 4. The treated liquid may be sufficiently clean to be recovered for re-use. However, if the treated liquid still contains unwanted contaminants, in particular organic contaminants, it may be recycled to the inlet 3 of the reservoir 2 through which it has passed, or it may be passed to a further treatment chamber or apparatus according to the present invention for further treatment.

In use, the liquid may flow through the chamber and bed of adsorbent material continuously or intermittently. In addition, the electric current may be passed through the liquid and adsorbent material continuously or intermittently.

Where the liquid passes through the chamber continuously, the flow rate of the liquid may be adjusted such that substantially all of the organic contaminants are removed from the water by the time the water passes out of the outlet. Similarly, when the liquid passes through the chamber intermittently, the dwell time is adjusted such that substantially all of the organic contaminants are removed from the water before the water passes out of the outlet.

The magnitude and direction of the current may be selected depending on the circumstances. For example, where the liquid to be treated is heavily contaminated, a larger current may be required. In addition, the polarity of the electrodes may be such that the adsorbent bed is cathodic. The adsorbent bed may be cathodic in cases where reduction of the contaminant is required. For example, the contaminated liquid may contain bromate ions and it is desirable to reduce the bromate ions to bromine.

The flow of liquid to be treated is generally downwards, namely from the top of the figure towards the bottom. The downward flow of the liquid and the weight of the particles comprising the adsorbent bed results in the adsorbent bed being slightly more compressed at the bottom when compared to the top. Therefore, the adsorbent bed has a higher conductivity at the bottom when compared to the top. Since the current passing between the electrodes takes the path of least resistance, this means that there is increased current flow between the electrodes towards the bottom of the chamber compared with the top. This may result in uneven wear of the second electrode as the lower part of the second electrode experiences greater current flow.

While a generally downward flow of liquid to be treated is indicated in FIG. 19, the opposite arrangement can also be used. Thus, liquid to be treated could be admitted at the bottom of the reservoir 2 and withdrawn from the top of the reservoir 2. It is preferable that there is some sort of filter at the discharge point because of the proximity of the adsorbent material. The direction of flow of the liquid through the reservoir 2 will be selected on the basis of the system requirements. Where the flow of liquid is generally downwards, it serves to slightly compress the adsorbent material and thus increase the conductivity of the bed of adsorbent material. Since the conductivity is increased, this may reduce the voltage required to pass through the adsorbent bed to regenerate the adsorbent and therefore lower power could be used. Alternatively, where the flow of the liquid is generally upwards, this has the opposite effect and spreads the adsorbent material out. This in turn decreases the conductivity of the bed and increases the power requirements. However, the upward flow may serve to expel gaseous by-products that are produced by oxidation of the contaminants in the bed of adsorbent material 5. Where the liquid to be treated flows generally downwards, the adsorbent bed 5 may act as a particulate filter and any particles entrained in the liquid to be treated will tend to accumulate in the upper portion of the adsorbent bed 5. This may result in inhibition of the flow of liquid through the bed 5. By reversing the flow of the liquid to be treated, this may serve as a backwash to expel accumulated particles and other contaminants. If the upward flow is great enough and there is no separator in place to stop the adsorbent material exiting the chamber, an upward flow may be used to remove at least a portion of the adsorbent bed 5 to create space for fresh adsorbent material to be added to the chamber.

The destruction of adsorbed contaminants is a surface-based phenomenon. The adsorbent material has a particular surface area onto which contaminants may be adsorbed. Once the surface is saturated, the adsorbent material is unable to adsorb further contaminants. When a current is passed through the adsorbent material, the adsorbed contaminants are broken down as described above and are released from the surface of the adsorbent material. Thus, the surface of the adsorbent material is able to adsorb further contaminants once the previously adsorbed contaminants have been broken down. Thus, the adsorbent may be regenerated by passage of an electric current through the adsorbent material.

The apparatus of the thirteenth aspect of the present invention is ideally suited for small scale water treatment applications. In one example of such use, the apparatus of the thirteenth aspect of the present invention may be used in a home water treatment application. In cases where there is no access to potable mains water, the apparatus of the thirteenth aspect of the present invention may be used as a full water treatment apparatus.

The adsorbent bed may serve to act as a filter to filter out insoluble materials entrained in the water. The entrained organic contaminants are adsorbed onto the surface of the adsorbent material and the adsorbent material is electrochemically regenerated by the passage of current through the adsorbent material. In addition, there may be a disinfectant precursor species present in the liquid to be treated. The disinfectant precursor species may be in solution in the liquid to be treated or may be added. A portion of the current flowing between the electrodes will pass through the liquid and convert the disinfectant precursor species into a disinfectant species. In particular, the disinfectant precursor species may comprise chloride ions and the disinfectant species may be an oxidised chloride species. The disinfectant species will diffuse throughout the liquid to be treated and provide an additional disinfectant action. Once the liquid has passed through the chamber, preferably it will be substantially free of organic contaminants and suitable for use. Generation of oxidised chlorine species can produce residual disinfection potential which will maintain a water suitable for storage prior to use.

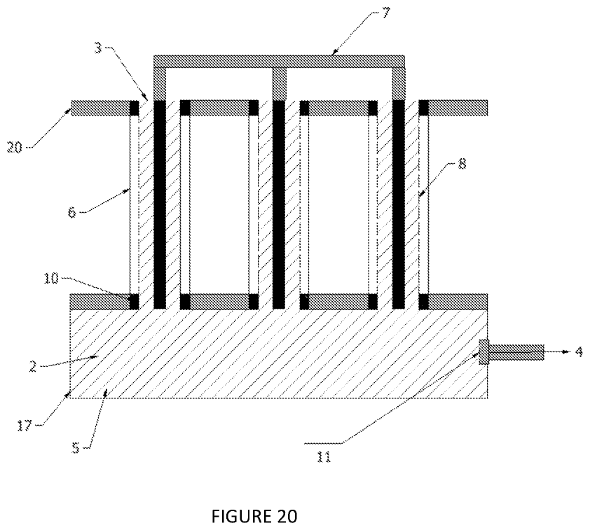

FIG. 20 illustrates an embodiment of the apparatus according to the fourteenth aspect of the present invention. The apparatus comprises a plurality of treatment reservoirs 2 similar to that illustrated in FIG. 19. Thus, similar components take the same reference numerals as in FIG. 19. The apparatus is effectively the same as that illustrated in FIG. 19 except that there is a plurality of reservoirs 2 in parallel with one another. As such, the second current feeders 7 are also connected in parallel. The reservoirs 2 may have a mesh or filter 11 provided at the bottom of each reservoir 2 which allows for the liquid to pass through and out of the reservoir 2 but which retains the adsorbent material comprising the bed 5 in the reservoir 2. Alternatively and preferably, each of the reservoirs 2 does not have a mesh or filter 11 at the bottom of the reservoir 2, but are instead connected to a common chamber 17. The common chamber 17 may have an outlet 4 through which treated water may exit. There is preferably a mesh or filter 11 which allows the passage of treated liquid, but retains the adsorbent material in the reservoir 2. FIG. 20 depicts the outlet 4 at the side of the reservoir 2. However, the outlet 4 may be located at any suitable position. For example, the outlet 4 may be located at the bottom portion of the common chamber 17 and may be located generally at the centre of the common chamber 17. The apparatus of the second aspect of the present invention may comprise two, three, four, five, or more treatment reservoirs 2. It will be appreciated that although there may be one continuous bed of adsorbent material, reference to reservoirs may relate to the tubular portions of the apparatus.

The apparatus according to the fourteenth aspect of the present invention may be connected in series with a second unit of the same apparatus. As such, the liquid to be treated may pass through the first apparatus and exit via the outlet 4. The liquid exiting the outlet 4 may then be passed to the inlet 3 of a second unit according to any aspect of the present invention. As such, a series of water treatment units which treat contaminated liquids by passing the liquid through a plurality of parallel reservoirs may be connected in series if further treatment of the liquid is required. The water treatment units may be the same or they may be different. The adsorbent material used in the water treatment units may also be the same or different. In addition, the current passed between the current feeders in the different water treatment units may be the same or different.

In use, the apparatus of the fourteenth aspect of the present invention may be operated in the same way as the thirteenth aspect of the present invention.

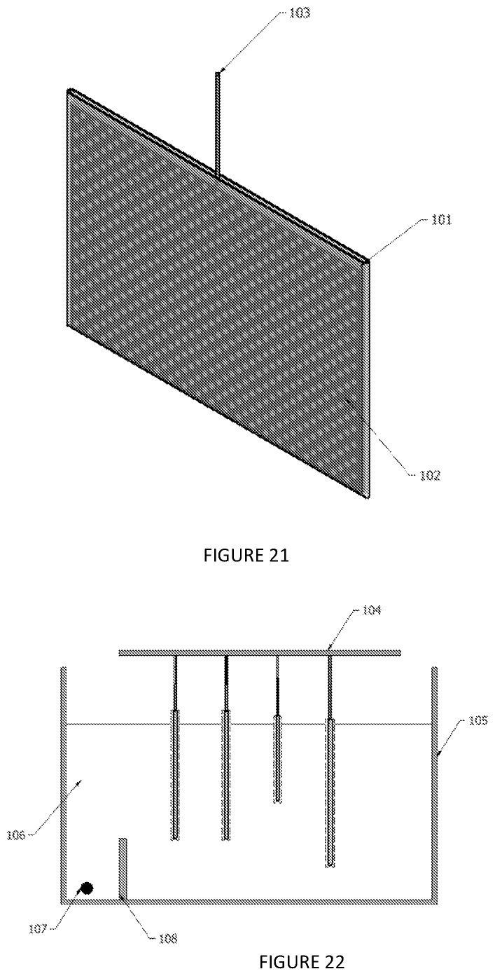

FIG. 21 depicts a current feeder in accordance with an aspect of the present invention. The current feeder may be used in combination with any other aspect of the present invention. The current feeder 101 may be made of any suitable material. The current feeder 101 may be in the form of a solid, expanded, or perforated metal plate. The current feeder 101 is substantially surrounded by a porous separator 102. The porous membrane 102 may be semi or selectively permeable or may be an ion-exchange membrane. This choice will depend on the conductivity of the effluent to be treated as effluents with higher conductivities can treated by a wider variety of porous separators. In low conductivity separators a membrane 102 that restricts that passage of hydroxide species through the membrane may be preferred. The top of the membrane 102 is preferably at least partially open. The opening 103 allows gases generated in the area between the membrane 102 and the current feeder 101 to exit to avoid pressure building up within the membrane 102. The opening 103 also allows an electrical connection to the current feeder to be made. Application of an electric field will allow liquid to transfer through the porous/permeable separator into the current feeder pocket through electro-osmosis. The opening 103 will allow this liquid to escape back into the liquid being treated where it will modify its pH back to its initial starting level.

FIG. 22 depicts an apparatus in which the current feeder may be used. FIG. 22 is simplified and the means for passing the liquid to be treated through the bed of adsorbent material 106 is not shown, although this could be through any arrangement that will allow for uniform contact of the effluent with the bed of adsorbent particles. A current feeder 107 is in electrical connection with the bed of adsorbent material 106. This will be separated from the current feeders 101 as in the first aspect of the application through placement in a non-porous, insulating zone of the reservoir effectively separating the second current feeder from the porous separator in order to force the current into the adsorbent material which is around 4 orders of magnitude more conducting that the aqueous liquid to be treated. Liquid to be treated is passed through the bed of adsorbent material 106. The current feeder 101 surrounded by membrane 102 are able to be inserted into the bed of adsorbent material 106 and the number, spacing and sizes of the current feeder 101 can be varied depending on the requirement of the system. As each current feeder 101 is at the same potential as it is connected to the power supply via a common connector 104 and the bed is maintained at a uniform potential through the insertion of a current feeder 107, the potential difference across the separator is the same, so the current density across the separator will the same. Thus, the separators can be of different sizes and there is no need for them to be equally spaced. Thus, if greater treatment capacity is required then more current feeders 101 can be added to the adsorbent bed 106. It should be appreciated that the shape of this apparatus is not limited to tubular systems (although it could be used within a tubular system) and any shape of vessel could be used. One particular application could be in retro-fitting existing tanks with a bed of adsorbent 106 and incorporating a number of current feeders 101 and a second current feeder 107. It will be appreciated that scale up of this system will be very straight forward. Thus, it is readily possible to adapt the system to take account of different operational needs.

The apparatus and methods of the present invention are suitable for a wide variety of application. For example, the apparatus may be used in an aquarium to treat the water in the aquarium. The water from the aquarium may be passed into the treatment reservoir by a small pump. In view of the low concentration of contaminants, a low power system is preferable. In addition, since the aquarium is likely to be home to living creatures, it is also safer to use a low power system. The apparatus and methods of the present invention are also suitable for other applications, including in the treatment of drinking water, hot tubs, air conditioning units, aquaculture, marine applications, industrial effluent treatment, disinfection applications, and many others.

The apparatus and methods according to the present invention offer numerous advantages over known apparatus for treatment of contaminated aqueous liquids. The apparatus of the present invention is simpler than known apparatus and may be made from ready available starting materials without the need for specialised fabrication. By using stainless steel piping, it is possible to have the piping act as both a current feeder/electrode as well as a structural part of the apparatus. Using a tubular system also assists in retrofitting the apparatus of the present invention into existing pipework. In addition, having a non-porous, insulating portion in the apparatus results in a more even charge distribution in the bed of adsorbent material and ensures that a larger proportion of the bed is able to be electrochemically regenerated when a current is passed through the bed and maximises the energy which is put into the bed.

### CLAUSES

Further aspects of the present invention are described in the following numbered clauses:
1. A method for treating a water stream comprising contaminants, the method comprising the steps of:
   a) mixing the water stream and a recycle stream in a first ratio to form a combined stream;
   b) electrochemically treating the combined stream in a first treatment zone of an electrochemical treatment unit having a first polarity to form a treated combined stream;
   c) dividing the treated combined stream into the recycle stream and a finishing stream in a second ratio; and
   d) passing the finishing stream to a second treatment zone having the opposite polarity to the first treatment zone to form an output stream.
2. The method of clause 1, wherein the first treatment zone is anodic.
3. The method of clause 1 or clause 2, wherein electrochemically treating the combined stream includes oxidising at least a portion of the contaminants and produces protons.
4. The method of any preceding clause, wherein the first ratio and the second ratio are selected such that the pH of the output stream is substantially the same as the pH of the water stream.
5. The method of any preceding clause, wherein the first ratio and/or the second ratio is in the range of from 100:1 to 1:100.
6. The method of any preceding clause, wherein the first ratio and the second ratio are substantially the same.
7. The method of any preceding clause, wherein a current is passed through the combined stream to effect the electrochemical treatment.
8. The method of any preceding clause, wherein the first treatment zone and the second treatment zone are comprised in the same electrochemical cell.
9. The method of any preceding clause, further comprising the step of adding acid to the water stream.
10. The method of any preceding clause, further comprising the step of adding base to the output stream.
11. The method of any preceding clause, further comprising the step of monitoring the pH of at least one of the water stream, recycle stream, combined stream, treated combined stream, finishing stream, and output stream.
12. The method of any preceding clause, further comprising the step of adjusting the first ratio and/or second ratio to maintain the pH of at least one of the combined stream, treated combined stream, recycle stream, finishing stream, and the output stream.
13. The method of any of clauses 7 to 12, further comprising the step of adjusting the current to control the pH of the combined stream, combined treated stream, recycle stream, finishing stream, and the output stream.
14. The method of clause 12 or clause 13, wherein the step of adjusting at least one of the first ratio, second ratio, and/or current is performed by a controller.
15. The method according to any preceding clause, wherein the method further comprises providing sodium chloride to a cathodic one of the treatment zones to produce a sodium hypochlorite solution.
16. The method according to any preceding clause, wherein the method further includes providing at least one of the streams to at least one other water treatment process.
17. The method according to Clause 16, wherein the at least one other water treatment process includes electrocoagulation, ion exchange resin, activated carbon, or electrofenton-based treatment.
18. The method according to Clause 16 or Clause 17, wherein the at least one other water treatment process is provided after step (b).
19. The method according to any preceding clause, wherein the water stream includes phosphate.
20. An apparatus for treating a water stream comprising contaminants, the apparatus comprising:
   a mixing means for mixing the water stream and a recycle stream;
   an electrochemical treatment unit comprising first and second treatment zones, said first treatment zone being in fluid communication with the mixing means;
   flow dividing means in fluid communication with the first electrochemical treatment zone for dividing a water stream leaving the first electrochemical treatment zone into the recycle stream and a finishing stream;
   said second electrochemical treatment zone being configured to receive the finishing stream.
21. The apparatus of clause 20, wherein the apparatus is arranged to form:
   a process loop comprising the mixing means, the first electrochemical treatment zone and the flow dividing means; and
   a finishing spur comprising the flow dividing means and the second electrochemical treatment zone.
22. The apparatus of clause 20 or clause 21, wherein the first and second electrochemical treatment zones comprise one or more current feeders operable to operate at a selected current.
23. The apparatus of any of clauses 20 to 22, wherein the first and second electrochemical zones are in the form of an electrochemical cell.
24. The apparatus according to clause 23, wherein the first and second electrochemical zones are separated by a separator, preferably a semi-permeable membrane
25. The apparatus according to clause 23 or 24, wherein one of the first and second electrochemical treatment zones is anodic and the other is cathodic.
26. The apparatus of any one of clauses 20 to 25, wherein the mixing means is operable to mix the water stream and the recycle stream in a first ratio.
27. The apparatus of any one of clauses 20 to 26, wherein the flow dividing means is operable to divide a stream received from the first treatment zone in a second ratio.
28. The apparatus of any one of clauses 20 to 27, wherein the first and/or the second treatment zones comprise a conductive particulate material.
29. The apparatus of clause 28, wherein the conductive particulate material comprises intercalated graphite.
30. The apparatus of any one of clauses 20 to 29, further comprising one or more pH monitors to monitor the pH of the fluid in at least one of the inlet, the mixing means, the first treatment zone, the flow dividing means, the second electrochemical treatment, and an outlet from the second treatment zone.
31. The apparatus of any one of clauses 20 to 30, further comprising a controller operable to adjust at least one of the current, the first ratio, and the second ratio.
32. The apparatus of any one of clauses 20 to 31, further comprising at least one other water treatment unit, optionally selected from an ion exchange resin, an electrocoagulation unit, or an electro-Fenton unit.
33. The apparatus according to Clause 32, wherein the apparatus is configured to provide at least a portion of the stream leaving the first electrochemical treatment zone to the at least one other water treatment unit.
34. Use of the apparatus of any of clauses 20 to 33 to treat contaminated water.
35. A current feeder comprising: a conductor, and an envelope comprising a porous separator material.
36. A current feeder according to Clause 35, wherein the conductor is substantially contained within the envelope.
37. A current feeder according to clause 35 or 36, wherein the conductor is substantially planar.
38. A current feeder according to any of clauses 35 to 37, wherein the envelope substantially surrounds the conductor.
39. A current feeder according to any of clauses 35 to 38, wherein the envelope has at least one opening.
40. A current feeder according to any of clauses 35 to 39, further comprising a vent.
41. A current feeder according to any of clauses 35 to 40, wherein the envelope is substantially sealed along its periphery.
42. A current feeder according to any of clauses 35 to 41, wherein the conductor is in the form of a solid, expanded, perforated, or mesh metal plate.
43. A current feeder according to any of clauses 35 to 42, wherein the porous separator is semi or selectively permeable, or is an ion-exchange membrane.
44. A current feeder according to any of clauses 35 to 43, wherein the porous separator material is non-conductive.
45. A current feeder according to any of clauses 35 to 44, wherein the porous separator material is at least one layer thick.
46. An apparatus for treating a contaminated aqueous liquid by contact with an adsorbent material to provide a treated liquid containing less contamination, the apparatus comprising:
   a treatment reservoir having an inlet for contaminated aqueous liquid and an outlet for treated liquid,
   a bed of adsorbent material,
   a first and a second current feeder for coupling to a source of electrical power, the first current feeder coupled with the bed of adsorbent material, and
   wherein the second current feeder comprises a conductor and an envelope comprising a porous separator material.
47. An apparatus according to Clause 46, wherein the apparatus comprises a plurality of second current feeders.
48. An apparatus according to Clause 47, wherein the porous separator material comprising the envelope of at least one of the plurality of second current feeders is different to the porous separator material comprising the envelope of at least one of the other second current feeders.
49. An apparatus according to any of Clauses 46 and 47, wherein the plurality of second current feeders are connected in parallel.
50. A method of treating a contaminated aqueous liquid by contact with an adsorbent material to provide a treated liquid containing less contamination, the method comprising delivering the liquid to an apparatus according to any of Clauses 46 to 49 and passing an electric current through the bed of adsorbent material to electrochemically regenerate the adsorbent material, and taking off the treated liquid from the outlet.
51. A method according to Clause 50, wherein the current feeders are operated continuously or intermittently.
52. Use of the current feeder, apparatus, or method according to any preceding clause in a process for the treatment of a contaminated aqueous liquid.
53. Apparatus for treating a contaminated aqueous liquid by contact with an adsorbent material to provide a treated liquid containing less contamination, the apparatus comprising:
   a tubular treatment reservoir having an inlet for contaminated aqueous liquid and an outlet for treated liquid,
   a bed of adsorbent material,
   a first and a second current feeder for coupling to a source of electrical power, a porous separator disposed between the bed of adsorbent material and the first current feeder,
   the second current feeder coupled with the bed of adsorbent material,
   wherein the treatment reservoir comprises a further portion comprising a non-porous, insulating material, wherein at least a portion of the second current feeder is separated from the first current feeder by the non-porous, insulating material.
54. Apparatus according to Clause 53, wherein at least a portion of the further portion of the treatment reservoir is provided between the first and second current feeders.
55. Apparatus according to any of Clauses 53 or 54, wherein the second current feeder is remote from the porous separator.
56. Apparatus according to any of clauses 53 to 55, wherein adsorbent material and/or liquid is provided between the porous separator and the first current feeder.
57. Apparatus according to any of clauses 53 to 56, wherein the porous separator is semi-permeable.
58. Apparatus according to any of clauses 53 to 57, wherein at least a portion of the second current feeder is planar or annular or tubular.
59. Apparatus according to any of clauses 53 to 58, wherein the porous separator is sealed at the bottom and open at the top.
60. Apparatus according to any of clauses 53 to 59, wherein the tubular treatment reservoir is defined substantially by the porous separator.
61. Apparatus according to any of clauses 53 to 60, wherein a mesh or filter is provided at the top and/or bottom of the treatment reservoir.
62. Apparatus according to any of clauses 53 to 61, wherein the first current feeder comprises at least a portion of a wall surrounding the treatment reservoir.
63. Apparatus according to any of clauses 53 to 62, wherein the first current feeder is substantially tubular.
64. Apparatus according to any of clauses 53 to 63, wherein the first current feeder comprises conducive material, or an insulating material coated with a conducting material or enclosing a substantially annular conductive material abutting or in close proximity to the inside of the insulating material.
65. Apparatus according to Clause 64, wherein the first current feeder comprises a stainless steel pipe.
66. Apparatus according to any of clauses 53 to 65, wherein the first current feeder is elongate.
67. Apparatus according to any of clauses 53 to 66, wherein the first current feeder is non-continuous and/or extends through an arc of the wall surrounding the treatment reservoir.
68. Apparatus according to any of clauses 53 to 67, wherein the second current feeder is substantially within the non-porous, insulating further portion and/or is located below the further portion away from the first current feeder.
69. Apparatus according to any of clauses 53 to 68, wherein the wall surrounding the treatment reservoir comprises at least one flange.
70. Apparatus according to Clause 53, wherein the at least one flange is at the top and/or bottom of the apparatus.
71. Apparatus according to any of clauses 53 to 70, wherein the wall of the treatment reservoir comprises one or more holes.
72. Apparatus according to any of clauses 53 to 71, wherein the apparatus further comprises a tank.
73. Apparatus according to Clause 72, wherein the tank comprises a catholyte solution.
74. Apparatus according to Clause 73, wherein the catholyte solution comprises sodium chloride and/or sodium sulphate.
75. Apparatus according to any of Clauses 53 to 74, wherein the porous separator is sealed at the top.
76. Apparatus according to any of clauses 53 to 75, wherein the first current feeder is remote from the porous separator.
77. Apparatus according to Clause 76 when dependent on any of Clauses 53 to 71, wherein the apparatus further comprises a tank
78. Apparatus according to Clause 77, wherein the tank comprises a catholyte solution.
79. Apparatus according to Clause 78, wherein the first current feeder is coupled to the catholyte solution.
80. Apparatus according to Clause 77, wherein the tank comprises a further bed of adsorbent material.
81. Apparatus according to of clauses 53 to 80, wherein the apparatus comprises a plurality of tubular treatment reservoirs.
82. Apparatus according to Clause 81, wherein the plurality of treatment reservoirs are connected in parallel or series.
83. Apparatus according to any of Clauses 81 or 82, wherein the plurality of treatment reservoirs is connected to a common chamber.
84. Apparatus according to Clause 83, wherein the common chamber and the plurality of treatment reservoirs comprise a continuous bed of adsorbent material.
85. Apparatus according to any of Clauses 81 to 84, wherein the plurality of reservoirs is connected to a common plate, which is preferably conductive.
86. Apparatus according to Clause 85, wherein the common plate is connected to the walls of the treatment reservoirs such that the walls and common plate are in electrical contact.
87. Apparatus for treating a contaminated aqueous liquid by contact with an adsorbent material to provide a treated liquid containing less contamination, the apparatus comprising:
   a tubular treatment reservoir having an inlet for contaminated aqueous liquid and an outlet for treated liquid,
   a bed of adsorbent material,
   a first and a second current feeder for coupling to a source of electrical power,
   a porous separator disposed between the bed of adsorbent material and the first electrode,
   at least a portion of the wall of the reservoir defining the first current feeder,
   at least a portion of the second current feeder being elongate and located in the bed of adsorbent material such that said second current feeder is spaced from said first current feeder.
88. Apparatus according to Clause 87, wherein the first current feeder substantially surrounds the tubular treatment reservoir.
89. Apparatus according to Clause 87 or 88, wherein at least a portion of the wall of the treatment reservoir is the first current feeder.
90. Apparatus according to Clause 89, wherein the wall of the reservoir is formed from a metallic pipe.
91. Apparatus according to any of Clauses 87 to 90, wherein the first current feeder is substantially annular.
92. Apparatus according to any of Clauses 87 to 91, wherein the first current feeder is non-continuous.
93. Apparatus according to any of Clauses 87 to 92, wherein the first current feeder extends through an arc of the wall of the treatment reservoir.
94. Apparatus according to any of Clauses 87 to 93, wherein a mesh or filter is provided at the bottom of the treatment reservoir
95. Apparatus according to any of Clauses 87 to 94, wherein the apparatus comprises a plurality of tubular treatment reservoirs.
96. Apparatus according to Clause 95, wherein the plurality of tubular treatment reservoirs are connected in series or parallel.
97. Apparatus for treating a contaminated aqueous liquid by contact with an adsorbent material to provide a treated liquid containing less contamination, the apparatus comprising:
   a plurality of tubular treatment reservoirs, each having:
   an inlet for contaminated aqueous liquid and an outlet for treated liquid,
   a bed of adsorbent material,
   a first and a second current feeder for coupling to a source of electrical power,
   a porous separator disposed between the bed of adsorbent material and the first current feeder,
   at least a portion of the walls of the reservoirs defining the first current feeder,
   at least a portion of the second current feeders being located in the bed of adsorbent material such that said second current feeders are spaced from said first current feeder.
98. Apparatus according to Clause 97, wherein the plurality of treatment reservoirs is connected to a common chamber.
99. Apparatus according to Clause 98, wherein the common chamber comprises a bed of adsorbent material to form a continuous bed in connection with each treatment reservoir.
100. Apparatus for treating a contaminated aqueous liquid by contact with an adsorbent material to provide a treated liquid containing less contamination, the apparatus comprising:
   a tank,
   a treatment reservoir having an inlet for contaminated aqueous liquid and an outlet for treated liquid,
   a bed of adsorbent material,
   a first and a second current feeder for coupling to a source of electrical power,
   a porous separator disposed between the bed of adsorbent material and the first current feeder,
   the second current feeder coupled with the bed of adsorbent material,
   wherein the tank contains a catholyte solution coupled to the first current feeder and the porous separator is arranged in at least one column extending into the tank, the adsorbent material being contained within the at least one column.
101. A current feeder substantially surrounded by a porous separator and having an opening at the top of the porous separator.
102. A current feeder according to Clause 101, wherein the current feeder is in the form of a solid, expanded, or perforated metal plate.
103. A current feeder according to any of Clauses 101 and 102, wherein the porous separator is semi or selectively permeable, or is an ion-exchange membrane.
104. A method of treating a contaminated aqueous liquid by contact with an adsorbent material to provide a treated liquid containing less contamination, the method comprising delivering the liquid to an apparatus according to any preceding clause and passing an electric current through the bed of adsorbent material to electrochemically regenerate the adsorbent material, and taking off the treated liquid from the outlet.
105. The use of the apparatus or method of any preceding clause in a process for the treatment of a contaminated aqueous liquid.

1. A method for treating a water stream comprising contaminants, the method comprising the steps of:
a) mixing the water stream and a recycle stream in a first ratio to form a combined stream;
b) electrochemically treating the combined stream in a first treatment zone of an electrochemical treatment unit having a first polarity to form a treated combined stream;
c) dividing the treated combined stream into the recycle stream and a finishing stream in a second ratio; and
d) passing the finishing stream to a second treatment zone having the opposite polarity to the first treatment zone to form an output stream.

2. The method of claim 1, wherein the first treatment zone is anodic.

3. The method of claim 1, wherein electrochemically treating the combined stream includes oxidising at least a portion of the contaminants and produces protons.

4. The method of claim 1, wherein the first ratio and the second ratio are selected such that the pH of the output stream is substantially the same as the pH of the water stream.

5. The method of claim 1, wherein the first ratio and/or the second ratio is in the range of from 100:1 to 1:100.

6. The method of claim 1, wherein a current is passed through the combined stream to effect the electrochemical treatment.

7. The method of claim 1, wherein the first treatment zone and the second treatment zone are comprised in the same electrochemical cell.

8. The method of claim 1, further comprising the step of adding acid to the water stream and/or further comprising the step of adding base to the output stream.

9. The method of claim 1, further comprising the step of adjusting the first ratio and/or second ratio to maintain the pH of at least one of the combined stream, treated combined stream, recycle stream, finishing stream, and the output stream.

10. The method of claim 1 wherein the method further comprises providing sodium chloride to a cathodic one of the treatment zones to produce a sodium hypochlorite solution.

11. The method of claim 1 wherein the method further includes providing at least one of the streams to at least one other water treatment process.

12. The method according to claim 11, wherein the at least one other water treatment process includes electrocoagulation, ion exchange resin, activated carbon, or electrofenton-based treatment.

13. The method of claim 10, wherein the at least one other water treatment process is provided after step (b).

14. The method of claim 1 wherein the water stream includes phosphate, optionally wherein the method includes recovering the phosphate via precipitation.

15. An apparatus for treating a water stream comprising contaminants, the apparatus comprising:
a mixing means for mixing the water stream and a recycle stream;
an electrochemical treatment unit comprising first and second treatment zones, said first treatment zone being in fluid communication with the mixing means;
flow dividing means in fluid communication with the first electrochemical treatment zone for dividing a water stream leaving the first electrochemical treatment zone into the recycle stream and a finishing stream;
said second electrochemical treatment zone being configured to receive the finishing stream.

16. The apparatus of claim 15, wherein the apparatus is arranged to form:
a process loop comprising the mixing means, the first electrochemical treatment zone and the flow dividing means; and
a finishing spur comprising the flow dividing means and the second electrochemical treatment zone.

17. The apparatus of claim 15, wherein the first and second electrochemical treatment zones comprise one or more current feeders operable to operate at a selected current.

18. The apparatus of claim 15, wherein the first and second electrochemical zones are in the form of an electrochemical cell.

19. The apparatus of claim 15, wherein the first and second electrochemical zones are separated by a separator, preferably a semi-permeable membrane

20. The apparatus of claim 15, wherein the mixing means is operable to mix the water stream and the recycle stream in a first ratio.

21. The apparatus of claim 15, wherein the flow dividing means is operable to divide a stream received from the first treatment zone in a second ratio.

22. The apparatus of claim 15, wherein the first and/or the second treatment zones comprise a conductive particulate material, optionally wherein the conductive particulate material comprises intercalated graphite.

23. The apparatus of claim 15, further comprising one or more pH monitors to monitor the pH of the fluid in at least one of the inlet, the mixing means, the first treatment zone, the flow dividing means, the second electrochemical treatment, and an outlet from the second treatment zone.

24. The apparatus of claim 15, further comprising at least one other water treatment unit, optionally selected from an ion exchange resin, an electrocoagulation unit, or an electro-Fenton unit, optionally wherein the apparatus is configured to provide at least a portion of the stream leaving the first electrochemical treatment zone to the at least one other water treatment unit.

25. Use of the apparatus of claim 15 to treat contaminated water.
